(19) United States
(12) Patent Application Publication
(10) Pub. No.: US 2022/0349527 A1
(43) Pub. Date: Nov. 3, 2022

(54) HYDROGEN STORAGE DEVICE

(71) Applicant: H2GO POWER LTD, London (GB)

(72) Inventors: Luke SPERRIN, London (GB); Enass ABO HAMED, London (GB); Peter ITALIANO, London (GB); Kieran O'DONNELL, London (GB)

(21) Appl. No.: 17/597,636

(22) PCT Filed: Jul. 17, 2020
(86) PCT No.: PCT/GB2020/051726

§ 371 Date: Jan. 14, 2022

(30) Foreign Application Priority Data
Jul. 19, 2019 (GB) 1910411.6
Mar. 26, 2020 (GB) 20004425.1

(51) Int. Cl. F17C 11/00; C01B 3/00

(52) U.S. Cl. CPC F17C 11/005; C01B 3/0031; C01B 3/0026; F17C 2221/012; F17C 2227/0304; F17C 2227/0337; F17C 2203/03; F17C 2250/043; F17C 2250/0439; F17C 2227/0309; F17C 2205/0142; F17C 2201/0109

(57) ABSTRACT

A hydrogen storage device (100A) comprises: a pressure vessel (230A), having a first fluid inlet (210A) and/or a first fluid outlet (220A), having therein a thermally conducting network (240A) optionally thermally coupled to a first heater and/or a first cooler; wherein the pressure vessel (230A) is arranged to receive therein a hydrogen storage material in thermal contact, at least in part, with the thermally conducting network (240A); wherein the thermally conducting network (240A) preferably has a lattice geometry, a gyroidal geometry and/or a fractal geometry in two and/or three dimensions, comprising a plurality of nodes, having thermally conducting arms therebetween, with voids between the arms; and wherein the thermally conducting network (240A) comprises fluidically interconnected passageways therein, for example within the arms and/or the nodes thereof, for flow therethough of a fluid.

### FIELD

The present invention relates to hydrogen storage devices.

### BACKGROUND TO THE INVENTION

Hydrogen is an environmentally-attractive alternative fuel to fossil fuels. Importantly, hydrogen can be produced without the use of fossil fuels, such as by the electrolysis of water using renewable energy. Hydrogen has a relatively high density of energy per unit mass and is effectively non-polluting since the main combustion product is water.

While hydrogen has wide potential application as a fuel, a major drawback in its utilization has been lack of suitable storage. Conventionally, hydrogen is stored in a pressure vessel as a compressed gas under a high pressure or stored as a cryogenic liquid, being cooled to an extremely low temperature. However, storage of hydrogen as a compressed gas generally involves use of large pressure vessels, limiting deployment at, for example, remote sites. Further, liquid hydrogen is expensive to produce while storage of hydrogen as a liquid presents a serious safety problem and requires storage below 20 K, thus precluding use in temporary installations, for example. Furthermore, scalability of storage, using conventional pressure vessels or liquid hydrogen, is limited by the associated infrastructure requirements, as mandated by safety and/or cost.

Hence, there is a need to improve storage of hydrogen.

### SUMMARY OF THE INVENTION

It is one aim of the present invention, amongst others, to provide a hydrogen storage device which at least partially obviates or mitigates at least some of the disadvantages of the prior art, whether identified herein or elsewhere. For instance, it is an aim of embodiments of the invention to provide a hydrogen storage device having an enhanced storage capacity, compared conventional storage of hydrogen. For instance, it is an aim of embodiments of the invention to provide a hydrogen storage device having improved safety, compared with conventional hydrogen storage. For instance, it is an aim of embodiments of the invention to provide a hydrogen storage device having improved control for charging and/or release of hydrogen.

A first aspect provides a hydrogen storage device comprising: a pressure vessel, having a first fluid inlet and/or a first fluid outlet, having therein a thermally conducting network optionally thermally coupled to a first heater and/or a first cooler; wherein the pressure vessel is arranged to receive therein a hydrogen storage material in thermal contact, at least in part, with the thermally conducting network; wherein the thermally conducting network preferably has a lattice geometry, a gyroidal geometry and/or a fractal geometry in two and/or three dimensions, comprising a plurality of nodes, having thermally conducting arms therebetween, with voids between the arms; and wherein the thermally conducting network comprises fluidically interconnected passageways therein, for example within the arms and/or the nodes thereof, for flow therethough of a fluid.

A second aspect provides a charging station for charging a hydrogen storage device according to the first aspect.

A third aspect provides a charging station assembly comprising a charging station according to the second aspect and a hydrogen storage device according to the first aspect.

A fourth aspect provides a method of storing hydrogen comprising passing hydrogen gas into a hydrogen storage device according to the first aspect, optionally comprising cooling the thermally conducting network.

A fifth aspect provides a method of providing hydrogen comprising releasing hydrogen gas from a hydrogen storage device according to the first aspect, optionally comprising heating the thermally conducting network.

### DETAILED DESCRIPTION OF THE INVENTION

According to the present invention there is provided a hydrogen storage device, as set forth in the appended claims. Also provided is a charging station for a hydrogen storage device and a charging station assembly comprising a hydrogen storage device and a charging station. Also provided is a method of charging a hydrogen storage device and a method of releasing hydrogen from a hydrogen storage device. Other features of the invention will be apparent from the dependent claims, and the description that follows. Hydrogen storage device

The first aspect provides a hydrogen storage device comprising: a pressure vessel, having a first fluid inlet and/or a first fluid outlet, having therein a thermally conducting network optionally thermally coupled to a first heater and/or a first cooler; wherein the pressure vessel is arranged to receive therein a hydrogen storage material in thermal contact, at least in part, with the thermally conducting network; wherein the thermally conducting network preferably has a lattice geometry, a gyroidal geometry and/or a fractal geometry in two and/or three dimensions, comprising a plurality of nodes, having thermally conducting arms therebetween, with voids between the arms; and wherein the thermally conducting network comprises fluidically interconnected passageways therein, for example within the arms and/or the nodes thereof, for flow therethough of a fluid.

In this way, control for charging and/or release of hydrogen from the hydrogen storage device is improved because the flow of the fluid through the interconnected passageways in the thermally conducting network provides for faster, more homogenous, more accurate and/or more precise heating and/or cooling of the thermally conducting network and in turn, the hydrogen storage material in thermal contact therewith. Additionally and/or alternatively, in this way, storing and/or release of the hydrogen may be accelerated since heat generated or required, respectively, may be provided by the flow of the fluid through the interconnected passageways in the thermally conducting network.

In one example, the hydrogen storage device comprises and/or is a first hydrogen storage device of a set of hydrogen storage devices, for example including a plurality of hydrogen storage devices. For example, a modular assembly, for example a stackable assembly, of hydrogen storage devices may be provided. Herein, the first hydrogen storage device refers also to the hydrogen storage device and vice versa. In one example, the pressure vessel comprises and/or is a first pressure vessel of a set of pressure vessels, for example including a plurality of pressure vessels. For example, a modular assembly of pressure vessels, for example a stackable assembly, may be provided. Herein, the first pressure vessel (also known as a first hydrogen storage vessel) refers also to the pressure vessel (also known as a hydrogen storage vessel) and vice versa. Hydrogen storage density

In one example, the first hydrogen storage device has a hydrogen storage density of at least 0.01 wt. %, at least 0.1 wt. %, at least 1.0 wt. %, at least 1.8 wt. %, preferably at least 2.4 wt. %, more preferably at least 3.3 wt. %, most preferably at least 5.5 wt. %, by wt. % of the first hydrogen storage vessel. In one example, the first hydrogen storage device has a hydrogen storage density of at most 50 wt. %, at most 40 wt. %, at most 30 wt. %, at most 25 wt. %, preferably at most 20 wt. %, more preferably at most 15 wt. %, most preferably at most 12.5 wt. %, by wt. % of the first hydrogen storage vessel. In this way, the hydrogen storage density may exceed energy storage in a Li-ion polymer battery (about 1.8 wt. % hydrogen storage density equivalent) and may exceed hydrogen storage density in a conventional compressed hydrogen cylinder at 300 bar.

### Hydrogen Storage Capacity

In one example, the first hydrogen storage device has a hydrogen storage capacity in a range from 1 g to 2,500 g, preferably in a range from 5 g to 1,000 g, more preferably in a range from 20 g to 500 g. Typically, 1 kg hydrogen may provide about 16.65 kWh of electrical energy, assuming a 50% efficiency in converting from chemical energy of the hydrogen to electrical energy, for example via a fuel cell. In this way, the first hydrogen storage device may provide an amount of electrical energy, via a fuel cell for example, in a range from 0.01665 kWh to 41.625 kWh, preferably in a range from 0.08325 kWh to 16.65 kWh, more preferably in a range from 0.333 kWh to 8.325 kWh.

### Pressure Vessel

The first hydrogen storage device comprises the pressure vessel, having the first fluid inlet and/or the first fluid outlet. In contrast to conventional pressure vessels for storage of compressed hydrogen gas, the pressure vessel is designed according to a relatively low operating pressure of at most 100 bar, preferably at most 75 bar, more preferably at most 50 bar, even more preferably at most 25 bar, most preferably at most 10 bar. Generally, a conventional pressure vessel for high pressure storage of hydrogen (i.e. 350 bar to 700 bar) is cylindrical, having dished ends. In contrast, since the pressure vessel is designed according to a relatively low operating pressure, a shape of the pressure vessel may be varied, while still maintaining an integrity and/or safety factor thereof. For example, the pressure vessel may be cuboidal such as a square based prism, thereby increasing space utilisation and/or enabling stacking thereof. For example, the pressure vessel may shaped aerodynamically (for example, for aircraft and land craft) or hydrodynamically (for water craft). In one example, the first hydrogen storage device, for example the pressure vessel, has at most two planes of symmetry, preferably having a shape arranged to reduce drag (i.e. shaped aerodynamically or hydrodynamically), in use. In one example, the pressure vessel has a moment of inertia I>½MR² about its central axis, where M is the mass of the pressure vessel and R is the mean radius of the pressure vessel, normal to the central axis. It should be understood that the moment of inertia I is determined for the empty pressure vessel shell i.e. not including the thermally conducting network, the hydrogen storage material, hydrogen, the first inlet and the first outlet. In one example, the pressure vessel comprises an insulating layer, arranged to thermally insulate the pressure vessel. In this way, control of a temperature of the pressure vessel is improved. In one example, the pressure vessel comprises a double wall (i.e. an inner pressure wall and an outer wall, for example an outer skin). In this way, a gap between the double wall may provide an insulating layer and/or comprise an insulating layer. In one example, the outer wall may be shaped aerodynamically or hydrodynamically and/or the inner wall is cylindrical, having dished ends. In this way, a wall thickness of the inner wall may be reduced for a given operating pressure, while the outer wall reduces drag. In addition, the outer wall may provide a physical buffer, reducing damage to the inner wall. In one example, the pressure vessel comprises a passageway arranged, for example axially, to receive the first heater therein. In one example, the passageway is a blind passageway. In one example, the passageway is a through passageway. In one example, the first heater comprises a Joule heater, for example a cartridge heater, and/or a recirculating heater, for example recirculating liquid, and the pressure vessel is arranged, for example comprising a passageway, to interchangeably receive the Joule heater and the recirculating heater therein and/or thereon. For example, the pressure vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the first hydrogen storage device comprises a passageway, wherein the first hydrogen storage device is arrangeable in: a first configuration to receive a Joule heater in the passageway; and a second configuration to receive a flow of a liquid through the passageway.

It should be understood that the first fluid inlet and the first fluid outlet are for the inlet of hydrogen into the pressure vessel and outlet of hydrogen from the pressure vessel, respectively, such as provided, at least in part, by a perforation (i.e. an aperture, a passageway, a hole) through a wall of the pressure vessel. In one example, the first fluid inlet and the first fluid outlet are a gas inlet and a gas outlet, respectively. In one example, the first fluid inlet and the first fluid outlet are provided by and/or via the same perforation. In one example, the pressure vessel has a plurality of gas inlets and/or gas outlets, including the first gas inlet and the first gas outlet respectively. In one example, the first fluid inlet and the first fluid outlet comprise releasable couplings, thereby providing coupling thereto and uncoupling therefrom, for example repeatedly, of corresponding couplings. Suitable releasable couplings (also known as fittings or connectors) include push-fit fittings, bayonet fittings, quick connect fittings, cylinder connections to BS341 or DIN 477, hose end fittings, pipe end fittings, tube end fittings and screw fittings. Other releasable couplings are known. In one example, the first hydrogen storage device comprises one or more of a thermocouple, a thermowell, a valve, a flashback arrestor, a filter such as a sorbent protection filter, a pressure sensor and a mass flow controller (MFC), for example inline with the first releasable fluid inlet coupling. A valve is generally movable between an open position in which hydrogen can enter or exit the vessel, and a closed position in which the vessel is sealed. In one example, the valve is electrically and/or pneumatically actuatable. In this way, the valve may be actuated remotely, for example via a controller. In one example, the MFC is electrically actuatable. In this way, the MFC may be actuated remotely, for example via a controller, to control flow of hydrogen therethrough.

### Hydrogen Storage Material

The pressure vessel is arranged to receive therein the hydrogen storage material in thermal contact, at least in part, with the thermally conducting network.

As an alternative to storage of hydrogen as a compressed gas or as a liquid, certain metals and alloys permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a solid hydride, a greater volumetric storage density may be achieved than possible for hydrogen as a compressed gas or as a liquid. In addition, hydrogen storage as a solid hydride presents a reduced safety risk compared with storing hydrogen as a compressed gas or as a liquid. In one example, the hydrogen storage material comprises and/or is a solid hydride.

For example, solid-phase metal or alloy materials can store large amounts of hydrogen by absorbing hydrogen with a high density and by forming a metal hydride under a specific temperature/pressure or electrochemical conditions, and hydrogen can be released by changing these conditions.

Generally, an efficiency of exchange of hydrogen into and out of such storage materials may be enhanced or inhibited by their respective heat transfer capabilities. Particularly, hydriding (also known as hydrogen absorption) is exothermic while dehydriding (also known as hydrogen desorption) is endothermic. Therefore, moving heat within such storage materials or maintaining preferred temperature profiles across and through volumes of such storage materials becomes a crucial factor in such metal or alloy hydride hydrogen storage materials. As a general matter, release of hydrogen from the crystal structure of a metal hydride requires input of some level of energy, normally heat. Placement of hydrogen within the crystal structure of a metal, metal alloy, or other storage system generally releases energy, normally heat, providing a highly exothermic reaction of hydriding or placing hydrogen atoms within the crystal structure of the hydrideable alloy.

The heat released from hydriding of hydrogen storage metals or alloys may be removed. Heat ineffectively removed can cause the hydriding process to slow down or terminate. This becomes a serious problem which prevents fast charging. During fast charging, the hydrogen storage material is quickly hydrogenated and considerable amounts of heat are produced. The hydrogen storage device described herein, particularly the thermally conducting network, provides for effective removal of the heat caused by the hydriding of the hydrogen storage alloys to facilitate fast charging of the hydride material. Approaches to this issue have been reported, for example in US 2003/0209149 and in “Heat transfer techniques in metal hydride hydrogen storage: A review”, Afzal et al., International Journal of Hydrogen Energy, 2017, 42(52), 30661-30682.

The hydrogen storage devices described herein allow for rapid charging and discharging of hydrogen gas while may also be relatively compact. Typically, heat is applied to discharge hydrogen gas, and heat is released and needs to be absorbed (for example, cooling applied) during hydrogen charging. The hydrogen storage devices allow for rapid heating and/or cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

The hydrogen storage material in the device of the invention can be a compound that is a metal hydride. Typically, the elemental metal reacts with hydrogen to form a metal hydride, for example:

Mg+H₂→MgH2

Generally, this reaction may be driven forwards by increasing hydrogen pressure.

Release of hydrogen occurs when heat is applied to the hydride. For example, for magnesium hydride and at 1 bar of pressure, MgH₂ decomposes to Mg metal and hydrogen at 287° C.:

Mg+H₂→Mg+H₂

In one example, the hydrogen storage material comprises one or more selected from: a metal for example an alkaline metal, an alkaline earth metal and/or a transition metal; and/or a hydride salt of a metal for example a hydride salt of an alkaline metal, an alkaline earth metal and/or a transition metal and/or a complex salt thereof; and/or a borohydride salt of a metal for example an alkaline metal, an alkaline earth metal and/or a transition metal; and/or a borohydride salt of ammonium and/or alkyl ammonium; and/or mixtures thereof. In one example, the hydrogen storage material comprises and/or is an ABₓ alloy, wherein A is at least one selected from a group consisting of La, Ce, Pr, Nd, Ca, Y, Zr, and Mischmetal, wherein B is at least one selected from a group consisting of Ni, Co, Mn, Al, Cu, Fe, B, Sn, Si, Ti, and x is in a range from 4.5 to 5.5. In one example, the hydrogen storage material comprises and/or is an AB/A₂B alloy, wherein A is at least one selected from a group consisting of Ti and Mg, and B is at least one selected from a group consisting of Ni, V, Cr, Zr, Mn, Co, Cu, and Fe. In one example, the hydrogen storage material comprises and/or is an AB2 alloy, wherein A is at least one selected from a group consisting of Ti, Zr, Hf, Th, Ce and rare earth metals, and B is at least one selected from a group consisting of Ni, Cr, Mn, V, Fe, Mn and Co. In one example, the hydrogen storage material comprises an ABₓ alloy, an AB/A₂B alloy, an AB₂ alloy, a hydride and/or a mixture thereof, as described above and/or below. In one example, the hydrogen storage material comprises at least one selected from a group consisting of Pd, Pt, Ni, Ru, and Re. In one example, the hydrogen storage material comprises one or more metal hydrides selected from a group consisting of: lithium hydride (LiH), sodium hydride (NaH), potassium hydride (KH), beryllium hydride (BeH₂), magnesium hydride (MgH₂), calcium hydride (CaH₂), strontium hydride(SrH₂), titanium hydride (TiH₂), aluminum hydride (AlH₃), boron hydride(BH₃), lithium borohydride (LiBH₄), sodium borohydride (NaBH₄), magnesium borohydride (Mg(BH₄)₂), calcium borohydride (Ca(BH₄)₂), lithium alanate (LiAlH₄), sodium alanate (NaAlH₄), magnesium alanate (Mg(AlH₄)₂), calcium alanate (Ca(AlH₄)₂), and mixtures thereof. In one example, the hydrogen storage material comprises and/or is one or more metal hydrides selected from MgH₂, NaAlH₄, LiAlH₄, LiH, LaNi₅H₆, TiFeH₂, palladium hydride PdHₓ, LiNH₂, LiBH₄ and NaBH₄. MgH₂, NaAlH₄, LiAlH₄, LiH and/or LaNi₅Hs are preferred. In one example, the hydrogen storage material comprises a mixture of two or more of these metal hydrides. These different metal hydrides may have different storage and/or release rates. Hence, a mixture of two or more of these metal hydrides may be selected for desired storage and/or release rates, for example under different conditions, and/or to provide relatively more constant storage and/or release rates under different conditions. In one example, the hydrogen storage material comprises a dopant such as a catalyst and/or an additive. For example, Ti and/or Zr may be used as catalytic dopants to improve kinetics of hydrogen storage and/or release, such as of sodium alanate. Although alkali metal alanates were known as non-reversible ‘chemical hydrides’, catalysed reversibility offers the possibility of a new family of low-temperature hydrides. For example, the alkali metal alanate-complex hydride, NaAlH₄, readily releases and absorbs hydrogen when doped with a TiCl₃ or Ti-alkoxide catalysts. There is currently ongoing research looking into optimisation of these catalysts in terms of their type, doping process and mechanistic understanding. Generally any appropriate transition or rare-earth metal can be used as catalysts, for example Ti, Zr, V, Mn, Fe, Ni, Co, Cr, Nb, Ge, Ce, La, Nd, Pd, Pr, Zn, Al, Ag, Ga, In and/or Cd. Additives include C, which improves thermal transfer of the hydrogen storage material. In one example, the hydrogen storage material is provided as particles (for example, in a powder form). In one example, the particles are microparticles, having a D50 or a D90 of at most 500 μm, at most 250 μm, at most 100 μm or at most 50 μm. In one example, the particles are microparticles having a D50 or a D10 of at least 1 μm, at least 5 μm, at least 10 μm or at least 25 μm. In one example, the particles are nanoparticles having a D50 or a D90 of at most 500 nm, at most 250 nm, at most 100 nm or at most 50 nm. In one example, the particles are nanoparticles having a D50 or a D10 of at least 1 nm, at least 5 nm, at least 10 nm or at least 20 nm. In one example, the particles are a mixture of particles of different sizes, for example a mixture of microparticles and nanoparticles, thereby having a bimodal particle size distribution. In this way, a packing efficiency for example a density and/or a surface area of the particles may be increased, thereby increasing storage of hydrogen and/or a rate of storage of hydrogen respectively. In one example, the hydrogen storage material is processed, for example by attrition such as ball milling, to reduce a particle size thereof and/or a particle size distribution thereof and/or to incorporate a dopant and/or an additive.

As an alternative to storage of hydrogen as a compressed gas or as a liquid, certain unsaturated organic compounds permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a LHOC, a greater volumetric storage density may be achieved than possible for hydrogen as a compressed gas or as a liquid, for example as a cryogenic liquid. In addition, hydrogen storage as a LOHC presents a reduced safety risk compared with storing hydrogen as a compressed gas or as a liquid. In one example, the hydrogen storage material comprises and/or is a LOHC.

For example, unsaturated organic compounds can store large amounts of hydrogen by absorbing hydrogen with a high density and by forming saturated organic compounds under a certain temperature/pressure conditions, and hydrogen can be released by changing these conditions.

Generally, an efficiency of exchange of hydrogen into and out of such storage materials may be enhanced or inhibited by their respective heat transfer capabilities. Particularly, hydrogenation (loading of LOC to LOHC, thereby storing hydrogen) is exothermic and dehydrogenation (unloading of LOHC to LOC, thereby releasing hydrogen) is endothermic. Therefore, moving heat within such storage materials or maintaining preferred temperature profiles across and through volumes of such storage materials becomes a crucial factor in such hydrogen storage materials.

Heat ineffectively supplied or removed causes hydrogenation and dehydrogenation to slow down or terminate. This becomes a serious problem which prevents fast charging and release. During fast charging and release, considerable amounts of heat are required to heat and cool the LOC and LOHC, respectively, and particularly, should be supplied homogeneously given the relatively low thermal conductivity of LOC and LOHC. The hydrogen storage device described herein, particularly the thermally conducting network, provides for effective heating and cooling of the hydrogen storage material to facilitate fast charging and release.

The hydrogen storage devices described herein allow for rapid charging and discharging of hydrogen gas while may also be relatively compact. The hydrogen storage devices allow for rapid heating and cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

In one example, the LOHC comprises and/or is a saturated cycloalkene, aromatic, heterocyclic aromatic and/or a mixture thereof. It should be understood that LOHC generally refers to the hydrogenated (i.e. loaded, saturated) liquid organic compound while LOC generally refers to the dehydrogenated (i.e. unloaded, unsaturated) liquid organic compound. However, in practice, a given molecular name may be used interchangeably to refer to both, with the correct meaning understood by the skilled person in the given context. Hence, for example, N-ethylcarbazole (NEC) may be referred to commonly as a LOHC yet is unsaturated. Research on LOHC was initially focussed on cycloalkanes, having a relatively high hydrogen capacity (6-8 wt. %) and production of COx-free hydrogen. Heterocyclic aromatic compounds (or N-Heterocycles) are also appropriate. N-Ethylcarbazole (NEC) is a well-known LOHC but many other LOHCs are known. With a wide liquid range between −39° C. (melting point) and 390° C. (boiling point) and a hydrogen storage density of 6.2 wt. %, dibenzyltoluene is ideally suited as LOHC material. Formic acid has been suggested as a promising hydrogen storage material with a 4.4 wt. % hydrogen capacity. Using LOHCs relatively high gravimetric storage densities can be reached (about 6 wt. %) and the overall energy efficiency is higher than for other chemical storage options such as producing methane from the hydrogen.

In one example, the LOHC comprises and/or is N-ethylcarbazole (NEC), monobenzyltoluene (MBT), dibenzyltoluene (DBT), 1,2-dihydro-1,2-azaborine (AB), toluene (TOL), naphthalene (NAP), benzene, phenanthrene, pyrene, pyridine, chinoline, flurene, carbazole, methanol, formic acid, phenazine, ammonia and/or mixtures thereof. Cycloalkanes reported as LOHCs include cyclohexane, methyl-cyclohexane and decalin. The dehydrogenation of cycloalkanes is highly endothermic (63-69 kJ/mol H₂), which means this process requires relatively high temperatures and/or heat inputs. Dehydrogenation of decalin is the most thermodynamically favored among the three cycloalkanes, and methyl-cyclohexane is second because of the presence of the methyl group. Ni, Mo and Pt based catalysts have been investigated for dehydrogenation. However, coking is still a big challenge for catalyst's long-term stability. Generally, hydrogenation and dehydrogenation of LOHCs requires catalysts. It was demonstrated that replacing hydrocarbons by hetero-atoms, like N, O etc. improves reversible de/hydrogenation properties. The temperature required for hydrogenation and dehydrogenation drops significantly with increasing numbers of heteroatoms. Among all the N-heterocycles, the saturated-unsaturated pair of dodecahydro-N-ethylcarbazole (12H-NEC) and NEC has been considered as a promising candidate for hydrogen storage with a fairly large hydrogen content (5.8 wt %). The standard catalyst for NEC to 12H-NEC is Ru and Rh based. The selectivity of hydrogenation can reach 97% at 7 MPa and 130° C. to 150° C. Although N-heterocyles can optimize the unfavorable thermodynamic properties of cycloalkanes, challenges include relatively high cost, high toxicity and/or kinetic barriers. Use of formic acid as a hydrogen storage material has been reported. Carbon monoxide free hydrogen has been generated in a very wide pressure range (1-600 bar). A homogeneous catalytic system based on water-soluble ruthenium catalysts selectively decompose HCOOH into H2 and CO2 in aqueous solution. This catalytic system overcomes the limitations of other catalysts (e.g. poor stability, limited catalytic lifetimes, formation of CO) for the decomposition of formic acid making it a viable hydrogen storage material. The co-product of this decomposition, carbon dioxide, can be used as hydrogen vector by hydrogenating it back to formic acid in a second step. The catalytic hydrogenation of CO2 has long been studied and efficient procedures have been developed. Formic acid contains 53 g L-1 hydrogen at room temperature and atmospheric pressure. By weight, pure formic acid stores 4.3 wt. % hydrogen. Pure formic acid is a liquid with a flash point 69° C. However, 85% formic acid is not flammable. Ammonia (NH3) releases H2 in an appropriate catalytic reformer. Ammonia provides high hydrogen storage densities as a liquid with mild pressurization and cryogenic constraints: It can also be stored as a liquid at room temperature and pressure when mixed with water. Ammonia is the second most commonly produced chemical in the world and a large infrastructure for making, transporting, and distributing ammonia exists. Ammonia can be reformed to produce hydrogen with no harmful waste.

In use, during storage of hydrogen, hydrogen may be received into the first vessel of the first hydrogen storage device via the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the first vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

In one example, the first hydrogen storage device comprises and/or is a static first hydrogen storage device. In such a static device, a predetermined volume of LOHC (for example, corresponding with at most an open volume of the first vessel) is received in the first vessel through the first fluid inlet and heated, via the thermally conducting network, thereby releasing hydrogen gas, which exits the first vessel via the first fluid outlet. When all the hydrogen is released from the LOHC, only liquid organic carrier, LOC, (i.e. unloaded LOHC) remains in the first vessel, and may be discharged (for example, for reloading) via the first fluid outlet or reloaded in the first vessel. Alternatively, in such a static device, a predetermined volume of liquid organic carrier, LOC, is received in the first vessel through the first fluid inlet together with hydrogen gas and heated and cooled, via the thermally conducting network, thereby storing the hydrogen gas in the LOC as the LOHC. When the LOC is fully loaded, only loaded LOHC remains in the first vessel. Hence, it should be understood that in the static device, the LOHC (or LOC) does not flow through the first vessel while releasing (or charging, respectively) the hydrogen. In one example, the static first hydrogen storage device comprises a mixer or stirrer, for mixing or stirring the LOHC (or LOC) therein, thereby improving an efficiency of dehydrogenation (or hydrogenation), respectively.

In contrast, in one example, the first hydrogen storage device comprises and/or is a dynamic (also known as flow-through) first hydrogen storage device. In such a dynamic device, a flow of LOHC is received, for example continuously, into the first vessel through the first fluid inlet and heated, via the thermally conducting network, thereby releasing hydrogen gas, which exits the first vessel together with the LOC (i.e. the unloaded LOHC) through the first fluid outlet. Alternatively, in such a dynamic device, a pressurised flow of LOC is received in the first vessel together with a flow of hydrogen gas and heated and cooled, via the thermally conducting network, thereby storing the hydrogen gas in the loaded LOC as the LOHC, which exits the first vessel through the first fluid outlet. Hence, it should be understood that in the dynamic device, the LOHC (or LOC) flows through the first vessel while releasing (or charging, respectively) the hydrogen. In one example, the first hydrogen storage device comprises a pump arranged to flow the hydrogen storage material through the first vessel.

In one example, the first hydrogen storage device comprises, is and/or is known as a reactor.

In one example, the pressure vessel comprises a lid (also known as a cover or a blanking plate, for example for an access hatch or an aperture in a wall of the pressure vessel) sealing coupled thereto and/or thereon, thereby providing a sealed pressure vessel around the thermally conducting network. The hydrogen storage material is advantageously added, generally in powder form, before the lid is sealing coupled to the pressure vessel. For example, if the hydrogen storage material is in powder form, the powder may be poured between arms of the thermally conducting network and optionally, into a foam to partially (i.e. at least 25%, preferably at least 35%, more preferably at least 45% by volume of voids), in a majority (i.e. at least 50%, preferably at least 60%, more preferably at least 70%, most preferably at least 80% by volume of voids), substantially (i.e. at least 90%, preferably at least 95%, more preferably at least 97.5% by volume of voids) and/or completely fill the pressure vessel. By filling the voids substantially with the powder, a hydrogen storage capacity is increased. Conversely, by filling the voids partially with the powder, heat transfer with the thermally conducting network may be improved. This filling may generally be carried out in an inert atmosphere environment, such as under argon, or other inert gas, before sealing the lid on the pressure vessel. Depending on the scale of manufacture, this may be carried out in a glove box. Slight agitation, for example vibration, can be advantageous, to ensure the powder percolates through the thermally conducting network and/or foam. In one example, the hydrogen storage device comprises an agitator, for example a vibrator, mechanically coupled to the pressure vessel and/or the thermally conductive network, arranged to agitate, for example vibrate, the pressure vessel and/or the thermally conductive network to thereby increase a filling efficiency of the pressure vessel with the hydrogen storage material.

In use, during storage of hydrogen, hydrogen may be received into the pressure vessel of the first hydrogen storage device via the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the pressure vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

### Thermally Conducting Network

The pressure vessel comprises therein the thermally conducting network thermally coupled to the first heater. In one example, a face of the thermally conducting network is in thermal contact (and hence thermally coupled to) the first heater. In one example, the first heater is integrally formed with and/or in the thermally conducting network, at least in part. For example, the first heater may be embedded within (i.e. internal to) the thermally conducting network.

The thermally conducting network may be formed from any suitable thermally conducting material for example a metal such as aluminium, copper, respective alloys thereof such as brass or bronze alloys of copper and/or stainless steel. Preferred materials also do not react with and/or are not embrittled by hydrogen and/or the hydrogen storage material, while having sufficient strength to maintain a structural integrity of the thermally conducting network. In one example, the thermally conducting network comprises a coating to reduce reaction with and/or embrittlement by hydrogen.

Preferably, the thermally conducting network has a lattice geometry, a gyroidal geometry and/or a fractal geometry in two and/or three dimensions.

In one example, the thermally conducting network has a lattice geometry, a gyroidal geometry and/or a fractal geometry in two and/or three dimensions (i.e. mutually orthogonal dimensions). A gyroid is an infinitely connected triply periodic minimal surface, similar to the lidnoid which is also within the scope of the first aspect. The gyroid separates space into two oppositely congruent labyrinths of passages, through which the hydrogen storage material may flow. It should be understood that such geometries comprise a plurality of nodes, having thermally conducting arms (i.e. generally elongated members) therebetween, with voids (i.e. gaps, space) between the arms. Such geometries, particularly the fractal geometry, provide relatively high surface area to volume ratios, enables especially efficient heat transfer to and from the hydrogen storage material. In one example, the fractal geometry is selected from a group consisting of a Gosper Island, a 3D H-fractal, a Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge and a Jerusalem cube. Certain fractal geometries, such as Gosper islands, allow for a plurality of individual repeat unit blocks to be fabricated and then assembled together in a tessellation (i.e. assembled together with no overlaps or gaps). This enables a plurality of channels to be provided in the thermally conducting network through the hydrogen storage device, whereby each channel has a high surface area, is of the same construction but does not leave wasted space between repeat units. In one example, an effective density (also known as lattice volume ratio) of the lattice geometry is uniform in one, two or three dimensions (i.e. mutually orthogonal dimensions). In one example, an effective density of the lattice geometry is non-uniform in one, two or three dimensions (i.e. mutually orthogonal dimensions). It should be understood that a uniform effective density in a particular dimension provides a constant void fraction, between arms of the lattice geometry, in the particular dimension. Conversely, it should be understood that a non-uniform effective density in a particular dimension provides a non-constant void fraction, between arms of the lattice geometry, in the particular dimension. A higher effective density will lead to faster heat conduction due to a higher thermally conducting material content. For example, the effective density may increase or decrease in the particular dimension, for example radially. In this way, the thermally conducting network may be designed, for example optimised, for a particular pressure vessel geometry so as to improve, for example optimise, heat transfer to and/or from the hydrogen storage material via the thermally conducting network. In one example, an effective density of the lattice geometry is uniform in a first dimension, for example axially, and non-uniform in mutually orthogonal second and third dimensions, for example radially. While the surface area to volume ratios of lattice geometries, for example square lattice geometries such as three-dimensional cages, are relatively lower than of fractal geometries having the same volumes, forming and/or fabrication of lattice geometries is relatively less complex and/or costly and hence may be preferred. In one example, the lattice geometry is Bravais lattice for example a triclinic lattice such a primitive triclinic lattice; a monoclinic lattice such as a primitive triclinic lattice or a base-centred triclinic lattice; an orthorhombic lattice such as a primitive orthorhombic lattice a base-centred orthorhombic lattice, a body-centred orthorhombic lattice or a face-centred orthorhombic lattice; a tetragonal lattice such as a primitive tetragonal lattice or a body-centred tetragonal lattice; a hexagonal lattice such as a primitive hexagonal lattice or a rhombohedral primitive lattice; or a cubic lattice such as a primitive cubic lattice, a body-centred cubic lattice or a face-centred cubic lattice. Other lattices are known. Hence, these Bravais lattices, for example define a plurality of regularly-arranged nodes having thermally conducting arms therebetween. In one example, the thermally conducting arms have a cross sectional dimension (for example a diameter or a width) in a range from 0.1 mm to 10 mm, preferably in a range from 0.25 mm to 5 mm, more preferably in a range from 0.5 mm to 2.5 mm and/or a length in range from 0.5 mm to 50 mm, preferably in a range from 1 mm to 25 mm, more preferably in a range from 2 mm to 10 mm. In this way, heat transfer of the thermally conducting network may be controlled by selecting an effective density and/or a surface area of the thermally conducting network.

In one example, the thermally conducting network is formed, at least in part, by 3D printing (i.e. additive manufacturing), for example by selective laser melting (SLM), thereby enabling forming of complex shapes in three dimensions having internal voids, for example. In one example, the thermally conducting network is formed, at least in part, by casting such as investment casting, moulding such as injection moulding and extrusion. Other additive manufacturing processes are known. In one example, the thermally conducting network is formed, at least in part, by fabrication and/or machining such as milling, turning or drilling. Other subtractive manufacturing processes are known.

The thermally conducting network comprises fluidically interconnected passageways therein, for example within the arms and/or the nodes thereof, for flow therethough of a fluid, such as a heating fluid and/or a coolant, preferably a liquid for example a recirculating liquid. In this way, heating and/or cooling of the thermally conducting network may be accelerated.

As described above, control for charging and/or release of hydrogen from the hydrogen storage device is improved because the flow of the fluid through the interconnected passageways in the thermally conducting network provides for faster, more homogenous, more accurate and/or more precise heating and/or cooling of the thermally conducting network and in turn, the hydrogen storage material in thermal contact therewith. Additionally and/or alternatively, in this way, storing and/or release of the hydrogen may be accelerated since heat generated or required, respectively, may be provided by the flow of the fluid through the interconnected passageways in the thermally conducting network.

It should be understood that the fluidically interconnected passageways are within, for example wholly within, the thermally conducting network, for example within the arms and/or the nodes thereof, such that at least some of the arms and/or the nodes thereof are tubular (i.e. having lumens therein) or shells (i.e. having cavities therein, hollow), respectively. That is, the passageways are internal to the thermally conducting network. In contrast, the voids (i.e. gaps, space) between the arms, as described above, are external to the thermally conducting network. In one example, at least some of the arms comprise tubular arms and/or at least some of the nodes comprise shells. In one example, walls of the arms and/or the nodes comprise no perforations therethrough. In this way, leakage of the fluid from the fluidically interconnected passageways is prevented and/or escape of hydrogen into the fluidically interconnected passageways is prevented. In one example, a wall thickness of the arms and/or the nodes is in a range from 0.01 mm to 5 mm, preferably in a range from 0.1 mm to 2.5 mm, more preferably in a range from 0.25 mm to 1.5 mm. In one example, the fluidically interconnected passageways define a flowpath (for example, a single flowpath) or a plurality of flowpaths (for example, parallel flowpaths), for example for recirculation of the fluid. In one example, the fluidically interconnected passageways define a capillary flowpath. In one example, the nodes provide bifurcations for the flow. In one example, the fluid is a liquid, selected for compatibility with a material of the thermally conducting network. The liquid may include one or more additives, such as corrosion inhibitors, to enhance compatibility with the material. For example, the liquid may be water, optionally comprising one or more corrosion inhibitor. In one example, surfaces of the fluidically interconnected passageways comprise a coating, for example to inhibit corrosion of the material of the thermally conducting network. In one example, the hydrogen storage device comprises a pump for pumping the fluid through the fluidically interconnected passageways. In one example, the hydrogen storage comprises a reservoir for the fluid, fluidically coupled to the fluidically interconnected passageways and optionally the pump. In one example, the first heater is arranged to heat the fluid. In one example, the first cooler is arranged to cool the fluid.

### Foam

In one example, the hydrogen storage device comprises a thermally-conducting foam, for example a metal foam, attached and/or attachable to (i.e. thermally coupled to, in thermal contact with, thermally coupleable to) the thermally conducting network. The inventors have found that such a foam aids heat transfer to and from the hydrogen storage material. It is known that such a foam has a high internal surface area. In one example, the foam comprises and/or is an open-celled foam, preferably an open-celled metal foam (also known as a metal sponge. Open-cell metal foams are generally manufactured by foundry or powder metallurgy. In the powder method, “space holders” are used; they occupy the pore spaces and channels. In casting processes, foam is typically cast with an open-celled polyurethane foam skeleton. The inventors have found that the hydrogen storage material may be placed in the spaces (i.e. voids, lumens, pores, cells) in the foam and the hydrogen storage material retains its ability to store and release hydrogen whilst at the same time benefiting from the enhanced rate of thermal transfer brought about by the high surface area of the foam. It should be understood that a foam pore size (i.e. cell size) is larger than a size of the hydrogen storage material, for example particles thereof. In one example, a ratio of the foam pore size to a particle size is at least 5:1, for example at least 10:1, for example 20:1, wherein sizes (i.e. foam pore size and particle size) are measurements in one dimension, for example diameter. In one example, the foam comprises and/or is a metal foam, preferably an open-celled metal foam, formed from aluminium, copper, stainless steel, nickel or zinc (or combination alloys including those metals). Aluminium foam is especially preferred. The thermally conducting network preferably contains metal foam in the spaces in the network. The voids in the metal foam contain the hydrogen storage material. It has been found that the metal foam in the fractal network provides excellent transfer of heat to and from the thermoelectric heater/cooler and the hydrogen storage material.

### Unfilled Volume

In one example, the hydrogen storage device is arranged to be oriented horizontally or vertically, in use. In one example, the thermally conducting network partially fills an internal volume of the pressure vessel, of at least 50%, preferably of at least 60%, more preferably of at least 70% by volume of the pressure vessel, thereby defining an unfilled volume, for example above the thermally conducting network. It should be understood that the volume of the thermally conducting network is the gross volume thereof, defined by an envelope thereof, and thus includes the volume of the voids therein in addition to the volume of the arms and nodes thereof. In one example, the unfilled volume acts as a buffer, providing a reservoir of hydrogen during charging and similarly during release, for example to account for kinetics thereof. In one example, the pressure vessel comprises a mesh or a perforated sheet, arranged to cover an open area of the thermally conducting network (i.e. not thermally coupled to the pressure vessel, for example), to thereby retain the hydrogen storage material in the voids defined within the thermally conducting network.

### Arrangements

In one example, the hydrogen storage device is arrangeable, for example repeatedly, in: a first arrangement wherein the thermally conducting network is within the pressure vessel; and a second arrangement wherein the thermally conducting network is outside the pressure vessel; optionally wherein the pressure vessel comprises a circumferential releasable joint. It should be understood that the first arrangement is the in use arrangement and the second arrangement is, for example, an assembly arrangement. In one example, the first inlet and/or the first outlet is arranged, for example sized, to permit insertion and/or removal of the thermally conducting network therethrough. In one example, the pressure vessel comprises a releasable port for insertion and/or removal of the thermally conducting network therethrough. In one example, the pressure vessel comprises a circumferential releasable joint, such that the pressure vessel may be parted to allow insertion and/or removal of the thermally conducting network. It should be understood that a circumferential joint includes a peripheral joint (i.e. around a periphery of the pressure vessel) and hence applies also to non-cylindrical pressure vessels. In one example, the pressure vessel comprises a longitudinal releasable joint, such that the pressure vessel may be parted to allow insertion and/or removal of the thermally conducting network. More generally, in one example, the pressure vessel comprises a releasable joint, such that the pressure vessel may be parted to allow insertion and/or removal of the thermally conducting network. In one example, the releasable joint comprises a mechanical fastener, for example a threaded joint, a bolted joint, a clamped joint. In one example, the releasable joint comprises a gasket. It should be understood that the releasable port and/or the releasable joint comply with standards for pressure vessels, as described above. In one example, the pressure vessel comprises a sealable joint, such that the pressure vessel may be manufactured in two or more parts to allow insertion of the thermally conducting network and the sealable joint subsequently sealed, for example permanently. In one example, the thermally conducting network comprises an expandable thermally conducting network. In this way, the thermally conducting network may be inserted through the first inlet and/or the first outlet into the pressure vessel and subsequently expanded, for use. For example, nodes of the thermally conducting network may be moveable nodes and/or arms of the thermally conducting network may be extensible arms. In one example, the thermally conducting network comprises an contractable thermally conducting network. In this way, the thermally conducting network may be removed through the first inlet and/or the first outlet into the pressure vessel by contracting the thermally conducting network and removing the contracted thermally conducting network, for use. For example, nodes of the thermally conducting network may be moveable nodes and/or arms of the thermally conducting network may be contractable arms. In this way, size of the first inlet and/or the first outlet may be relatively small, compared with an expanded size of the thermally conducting network. In one example, the thermally conducting network comprises a foldable, such as a foldable tessellated, structure of nodes and arms.

### Heater

The hydrogen storage device optionally comprises the set of heaters including the first heater. In one example, the hydrogen storage device comprises the set of heaters including the first heater and the thermally conducting network is thermally coupled to the first heater. By heating the first heater, heat is transferred to the thermally conducting network thermally coupled thereto. In turn, heat is transferred to the hydrogen storage material in thermal contact, at least in part, with the thermally conducting network. In this way, the hydrogen storage material is heated by the first heater, via the thermally conducting network, thereby causing hydrogen to be released from the hydrogen storage material. In one example, the first heater is positioned inside the pressure vessel. In one example, the first heater is positioned outside of the pressure vessel. Positioning the first heater outside the pressure vessel simplifies certain aspects of the assembly of the device and allows simpler access for electrical wiring. In one example, the first heater comprises and/or is a thermoelectric heater and/or a Joule heater, and/or a recirculating heater, for example recirculating liquid, and the first vessel is arranged, for example comprising a passageway, to interchangeably receive the Joule heater and the recirculating heater therein and/or thereon. For example, the first vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the first hydrogen storage device comprises a passageway, wherein the first hydrogen storage device is arrangeable in: a first configuration to receive a Joule heater in the passageway; and a second configuration to receive a flow of a liquid through the passageway. Other heaters are known. In one example, the hydrogen storage device comprises a thermocouple connected to the first heater, for example via a proportional-integral-derivative (PID) control. In this way, a temperature of the first heater may be controlled. In one example, the first heater comprises and/or is a cartridge heater or an insertion heater. Generally, cartridge heaters are elongated cylinders including electrical resistive wire, for example embedded in magnesium oxide. Suitable cartridge heaters and insertion heaters are available from Watlow (MO, USA). In one example, the first heater is inserted into a passageway formed in and/or provided by the thermally conducting network. In one example, the first heater is integrated into the thermally conducting network, for example integrally formed therewith. In this way, a heating efficiency of the thermally conducting network is improved. In one example, the hydrogen storage device comprises a battery, preferably a rechargeable battery for example a Li-ion polymer battery, arranged to provide electrical power to the first heater.

In one example, the first hydrogen storage device comprises a set of heater/coolers, including the set of heaters, including a first heater/cooler, comprising the first heater. By cooling the first heater/cooler, heat is transferred from the thermally conducting network thermally coupled thereto. In turn, heat is transferred from the hydrogen storage material in thermal contact, at least in part, with the thermally conducting network. In this way, the hydrogen storage material is cooled by the first heater/cooler, via the thermally conducting network, thereby allowing hydrogen to be stored in the hydrogen storage material. In other words, the first heater/cooler can, in a space-efficient manner, enable heat to be removed from the hydrogen storage material during the hydrogen storage phase, and heat to be supplied to the hydrogen storage material during hydrogen release. In one example, the first heater/cooler is positioned inside the pressure vessel. In one example, the first heater/cooler is positioned outside of the pressure vessel. Positioning the first heater/cooler outside the pressure vessel simplifies certain aspects of the assembly of the device and allows simpler access for electrical wiring. Thermoelectric heater and/or cooler devices can be very closely controlled (i.e. accurately, precisely and/or responsively), which providing control to a high degree of accuracy, precision and/or short response times. The heater of the first heater/cooler may be as described above with respect to the first heater. In one example, the cooler of the first heater/cooler comprises and/or is a heat sink, optionally with active cooling by air propelled by a fan or by a cooling fluid (e.g. water) being propelled by a pump. In one example, the first heater/cooler comprises and/or is a Peltier device or other device that makes use of thermoelectric cooling and heating. Devices of this type are commonly referred to as a Peltier heat pump, a solid state refrigerator, or a thermoelectric cooler (TEC). A thermoelectric heater and cooler device may be used together with a heat sink with optional active cooling (e.g. active cooling by air propelled by a fan or active cooling by a cooling fluid (e.g. water) being propelled by a pump). Application of heat or removal of heat on the side of the thermoelectric device that is not thermally coupled to the thermally conducting network enhances the ability of the thermoelectric device to heat and cool the thermally conducting network. In one example, the first heater/cooler (e.g. a thermoelectric heater and cooler) is in thermal contact with the thermally conducting network. As the two are in thermal contact, heat can efficiently be passed from one to the other. The heat can pass in either direction-heating the thermally conducting network or cooling it. The contact between the heater/cooler module and the thermally conducting network need not be direct physical contact. In some embodiments, there are intervening materials, such as a wall of the pressure vessel. In such an embodiment, the intervening material must continue to allow for good thermal contact between the heater/cooler module and the thermally conducting network, such that heat can pass efficiently from one to the other. Suitable thermoelectric heater and/or cooler devices are known to the person skilled in the art and they are available commercially from most electronics suppliers, such as CUI Inc (OR, USA). In one example, the first hydrogen storage device comprises one or more of thermoelectric heaters and/or coolers on a base to provide a Peltier heater/cooler assembly, wherein the thermally conducting network is thermally coupled (for example, attached) to the Peltier heater/cooler assembly. For example, the thermally conducting network may be 3D printed onto the heater/cooler assembly. Optionally, foam (for example metal foam, as described below) may be attached to the thermally conducting network, for example by application of an appropriate amount of compression. Alternatively, the foam may be attached by a physical bond for example by soldering, brazing and/or welding the thermally conducting network and foam together. In such an arrangement, it is preferred for the solder and/or filler to have high thermal conductivity, which is the case for most solder and filler materials.

In one example, the first heater comprises a Joule heater and/or a recirculating heater, preferably wherein the first hydrogen storage device, for example the pressure vessel, is arranged to interchangeably receive the Joule heater and the recirculating heater therein and/or thereon, as described above.

### Phase Change Materials

In one example, the first hydrogen storage device comprises a phase change material (PCM) in thermal contact, at least in part, with the thermally conducting network. In this way, heat arising during hydrogen storage may PCMs are materials having high heats of fusion and which, upon changing phase at respective phase change temperatures such as by melting and solidifying, are capable of storing and/or releasing large amounts of energy. PCMs may be classified as latent heat storage (LHS) units. Latent heat storage can be achieved through liquid-solid, solid-liquid, solid-gas and liquid-gas phase changes. However, only solid-liquid and liquid-solid phase changes are generally practical for PCMs. In one example, the PCM is a solid-liquid (and liquid-solid) PCM. In one example, the first hydrogen storage device comprises a phase change material (PCM) in thermal contact, at least in part, with the thermally conducting network. In this way, at least some of the heat arising during storage of hydrogen by the hydrogen storage material may be stored in the PCM and subsequently released therefrom, to effect at least in part release of hydrogen from the hydrogen storage material.

Consider a typical temperature profile of a solid-liquid PCM during thermal loading. Initially, below a temperature Ts, the PCM behaves as a sensible heat storage (SHS) material such that a temperature of the PCM rises as the PCM absorbs heat. Unlike conventional SHS materials, however, when the PCM reaches a phase change temperature Ts at which it changes phase (i.e. melting temperature), the PCM absorbs large amounts of heat at an almost constant temperature. The PCM continues to absorb heat without a significant rise in temperature until all the PCM is transformed to the liquid phase. When the ambient temperature around a liquid material falls, the PCM solidifies, releasing its stored latent heat. In this way, PCMs may store about 5 to about 14 times more heat per unit volume than conventional heat storage materials such as water, masonry or rock.

In one example, the PCM comprises at least one of an organic PCM, an inorganic PCM, an eutectic PCM, a hygroscopic PCM, a solid-solid PCM and a thermal composite. In selection of a PCM, one or more of the following properties may be desirable: phase change temperature in a desired operating temperature range, high latent heat of fusion per unit volume, high specific heat, high density and high thermal conductivity, small volume change on phase transformation, small vapour pressure at operating temperatures, congruent melting, high nucleation rate to avoid supercooling of a liquid phase, high rate of crystal growth, chemical stability, reversibility of phase change, absence of degradation due to phase change, non-corrosiveness, non-toxic, non-flammable, low cost and/or availability.

Organic PCMs include, for example, paraffins (CₙH₂ₙ₊₂), carbohydrates and lipid-derived materials. Beneficial properties of organic PCMs may include freezing without much undercooling, melting congruently, self-nucleation, compatibility with conventional material of construction, no or little segregation, chemically stability, high heat of fusion, safe and non-reactivity and/or recyclability. In addition, carbohydrate and lipid based PCMs may be produced from renewable sources. However, organic PCMs may have low solid thermal conductivities, require high heat transfer rates during the freezing cycle, low volumetric latent heat storage capacities and/or flammabilities. To obtain reliable phase change points, manufacturers typically provide technical grade paraffins, which are essentially paraffin mixture(s) and are completely refined of oil.

Inorganic PCMs include salt hydrates (MₙH₂ₙ₊₂), for example. Beneficial properties of inorganic PCMs may include high volumetric latent heat storage capacity, availability, low cost, sharp melting point, high thermal conductivity, high heat of fusion and/or non-flammability. However, inorganic PCMs may have high changes of volume, super cooling in solid-liquid transition and/or nucleating agents may be required.

Organic and inorganic PCMs are available from Rubitherm Technologies GmbH (Berlin, Germany), for example, having phase change temperatures in a range of from −9° C. to 90° C. Heat storage capacities of these PCMs range typically from 150 kJ/kg to 290 kJ/kg.

Eutectic PCMs include, for example, c-inorganic and inorganic-inorganic compounds. Beneficial properties of eutectic PCMs may include sharp melting point and/or improved volumetric storage density compared with organic PCMs. Hygroscopic PCMs include, for example, natural building materials such as wool insulation and earth/clay render finishes, that can absorb and release water. Solid-solid PCMs undergo solid/solid phase transitions with associated absorption and release of large amounts of heat, having latent heats comparable with solid/liquid PCMs. Nucleation may not be required to prevent supercooling. Currently the temperature range of solid-solid PCMs are available having phase change temperatures in a range of from 25° C. to 180° C.

In one example, a phase change temperature of the PCM corresponds with a desorption temperature of the hydrogen storage material, in use. For example, hydrated salt S58 (available from PCM Products Ltd, UK) has a phased change temperature of 58° C. which corresponds with a desorption temperature temperature of lanthanum nickel (LaNi₅H₆) of 60° C.

In one example, the phase change temperature is within 20° C., preferably within 10° C., more preferably within 5° C. of a desorption temperature of the hydrogen storage material. In one example, the phase change temperature is at most 20° C., preferably at most 10° C., more preferably at most 5° C. above a desorption temperature of the hydrogen storage material.. In this way, an efficiency of heat storage and release by the PCM is improved, since hysteresis is reduced.

In one example, the PCM has a heat storage capacity in a range of from 100 kJ/kg to 1000 kJ/kg, preferably of from 150 kJ/kg to 500 kJ/kg, more preferably of from 200 kJ/kg to 300 kJ/kg, for example 230 kJ/kg. Generally, higher heat storage capacities are preferable. However, the first phase change temperature of the PCM may be a determining factor in selection, thereby limiting candidate PCMs.

In one example, the PCM comprises an encapsulated PCM. Encapsulation of the PCM may be required for PCMs undergoing solid-liquid phase transformations. Example of encapsulation include macro-encapsulation, micro-encapsulation and molecular encapsulation. Macro-encapsulation with large volume containment may be unsuitable for PCMs having low thermal conductivity, since such PCMs tend to solidify at edges of the macro-encapsulation, thereby preventing effective heat transfer. Micro-encapsulation generally allows PCMs to be incorporated into construction materials, for example by coating a microscopic sized PCM with a protective coating. Molecular-encapsulation allows a very high concentration of PCM within a polymer compound. In one example, the encapsulated PCM is divided into cells. The cells may be arranged to reduce static head. Walls of the cells may provide effective heat transfer, restrict passage of water through the walls, resist leakage and/or corrosion and/or may be chemically compatible with the PCM. Cell wall material examples include stainless steel, polypropylene and polyolefin. In one example, the PCM comprises an additive arranged to increase a thermal conductivity of the PCM. Some PCMs, for example some organic PCMs, may have high heats of fusion but low thermal conductivities. By including additives within the PCM, the thermal conductivity of the PCM may be increased, thereby improving heat absorption of the PCM, for example. The additives may include, for example, particles, fibres or wires, having high thermal conductivities.

### Charging Station

The second aspect provides a charging station for charging a hydrogen storage device according to the first aspect. In one example, the charging station is arranged to charge a plurality of hydrogen storage devices, for example simultaneously. In one example, the charging station comprises a manifold coupleable to a plurality of hydrogen storage devices. In one example, the charging station comprises a cooling system, arranged to cool a hydrogen storage device during charging thereof. In one example, the cooling system comprises a fan, a bath, a cooling jacket and/or a recirculating coolant system.

### Assembly

The third aspect provides a charging station assembly comprising a charging station according to the second aspect and a hydrogen storage device according to the first aspect.

### Method

The fourth aspect provides a method of storing hydrogen comprising passing hydrogen gas into a hydrogen storage device according to the first aspect, optionally comprising cooling the thermally conducting network, for example by flowing the fluid through the fluidically interconnected passageways. In one example, the method comprises cooling the fluid. In one example, the method comprises pumping the fluid.

The fifth aspect provides a method of providing hydrogen comprising releasing hydrogen gas from a hydrogen storage device according to the first aspect, optionally comprising heating the thermally conducting network, for example by flowing the fluid through the fluidically interconnected passageways. In one example, the method comprises heating the fluid. In one example, the method comprises pumping the fluid.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 is a CAD axial cross-section of a hydrogen storage device according to an exemplary embodiment;

FIG. 2 is a CAD axial cross-section of the hydrogen storage device of FIG. 1;

FIG. 3 schematically depicts a cutaway, perspective view of a simulation of the of the hydrogen storage device of FIG. 1;

FIG. 4A is a schematic axial cross-section of a hydrogen storage device according to an exemplary embodiment and FIGS. 4B to 4D are schematic transverse cross-sections of the hydrogen storage device of FIG. 4A;

FIGS. 5A to 5C schematically depict thermally conducting networks for a hydrogen storage device according to an exemplary embodiment;

FIG. 6A is a photograph of a foam for a hydrogen storage device according to an exemplary embodiment; and FIG. 6B is a schematic view of a hydrogen storage device according to an exemplary embodiment, in more detail;

FIG. 7A is a plan elevation view of a hydrogen storage device according to an exemplary embodiment; and FIG. 7B is a side cross-sectional view of the hydrogen storage device of FIG. 7A;

FIG. 8 is a CAD cutaway perspective view of a hydrogen storage device according to an exemplary embodiment;

FIG. 9 is a CAD axial cross-section of the hydrogen storage device of FIG. 10;

FIG. 10 is a CAD radial cross-section of the hydrogen storage device of FIG. 10;

FIG. 11 is an alternative CAD radial cross-section of the hydrogen storage device of FIG. 10;

FIG. 12 is a CAD cutaway perspective view of a hydrogen storage device according to an exemplary embodiment;

FIG. 13 is a CAD axial cross-section of the hydrogen storage device of FIG. 12;

FIG. 14 is a CAD radial cross-section of a thermally conducting network of the hydrogen storage device of FIG. 12;

FIG. 15 schematically depicts Bravais lattices for a thermally conducting network;

FIG. 16 is a CAD perspective view of a hydrogen storage device according to an exemplary embodiment;

FIG. 17 is a CAD axial cross-section of the hydrogen storage device of FIG. 16;

FIG. 18 is a CAD axial cross-section of a hydrogen storage device according to an exemplary embodiment;

FIG. 19 is a CAD perspective view of a charging station assembly according to an exemplary embodiment;

FIG. 20 shows the periodic table of elements, showing suitability of elements for hydrogen storage according to HHI Production, HHI Reserve and Abundance of the elements, where HHI is the Herfindahl-Hirschman index, a commonly accepted measure of market concentration, has been calculated from geological data (known elemental reserves) and geopolitical data (elemental production) for much of the periodic table;

FIG. 21 shows a chart of gravimetric H₂ density (wt. %) as a function of volumetric H₂ density (kg H₂/m³) for metal hydrides, chemical hydrogen and absorbents;

FIG. 22 shows a chart of observed H₂ capacity (wt. %) as a function of temperature, showing H₂ sorption temperature (° C.) and temperature for observed H₂ release (° C.), for metal hydrides, chemical hydrogen and absorbents;

FIG. 23A is a CAD perspective view of a hydrogen storage device according to an exemplary embodiment; FIG. 23B is a CAD perspective semi-transparent view of the hydrogen storage device of FIG. 23A; and FIG. 23C is a CAD axial cross-section view of the hydrogen storage device of FIG. 23A;

FIG. 24A is a cutaway perspective view of a hydrogen storage device according to an exemplary embodiment; and FIG. 24B is a cutaway perspective exploded view of a related hydrogen storage device;

FIG. 25 is a cutaway perspective view of a hydrogen storage device according to an exemplary embodiment;

FIG. 26A is a CAD partial cutaway perspective view of a hydrogen storage device according to an exemplary embodiment; FIG. 26B is a CAD longitudinal perspective cross-sectional view of the hydrogen storage device; and FIG. 26C is a CAD perspective view of the thermally conducting network, in more detail

FIG. 27A is a CAD partial cutaway perspective view of a hydrogen storage device according to an exemplary embodiment; and FIG. 27B is a CAD transverse cross-sectional view of the hydrogen storage device;

FIG. 28A is a CAD partial cutaway perspective view of a hydrogen storage device according to an exemplary embodiment; FIG. 28B is a CAD partial cutaway perspective view of the hydrogen storage device, in more detail; and FIG. 28C is a CAD exploded perspective view of a part of the hydrogen storage device, in more detail;

FIG. 29A is a CAD partial cutaway perspective view of a hydrogen storage device according to an exemplary embodiment; and FIG. 29B is a CAD longitudinal cross-sectional view of the hydrogen storage device;

FIG. 30 is a CAD partial cutaway exploded perspective view of a hydrogen storage device according to an exemplary embodiment;

FIG. 31 is a CAD transverse cross-sectional view of a hydrogen storage device according to an exemplary embodiment; and

FIG. 32 is a CAD partial cutaway perspective view of a hydrogen storage device according to an exemplary embodiment.

### DETAILED DESCRIPTION OF THE DRAWINGS

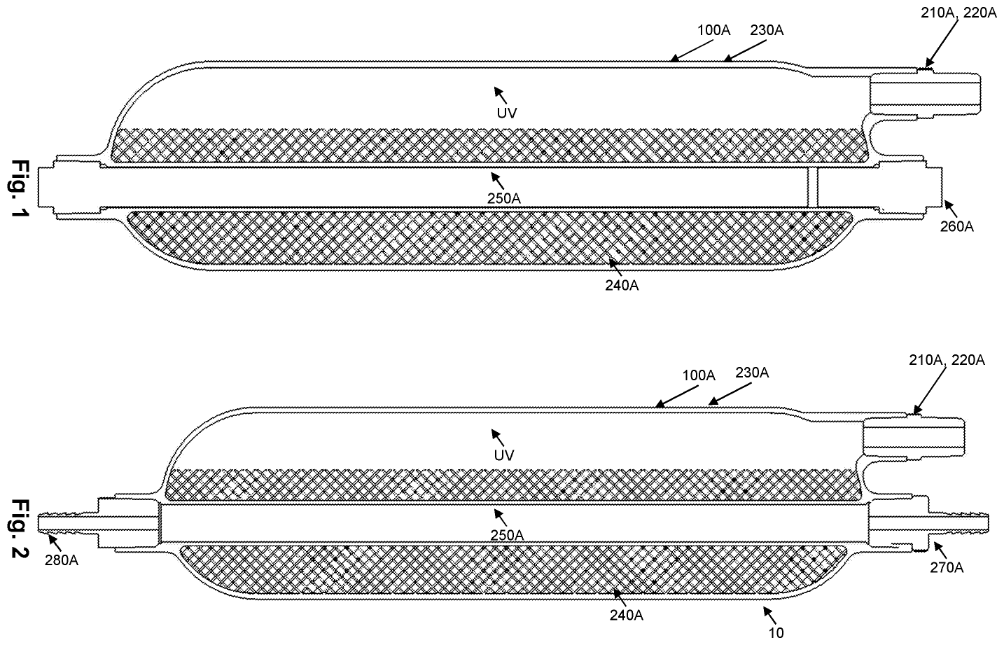

FIG. 1 is a CAD axial cross-section of a hydrogen storage device 100A. FIG. 2 is a CAD axial cross-section of the hydrogen storage device 100A of FIG. 1. In this example, the hydrogen storage device 100A comprises: a pressure vessel 230A, having a first fluid inlet 210A and/or a first fluid outlet 220A, having therein a thermally conducting network 240A optionally thermally coupled to a first heater and/or a first cooler; wherein the pressure vessel 230A is arranged to receive therein a hydrogen storage material in thermal contact, at least in part, with the thermally conducting network 240A; wherein the thermally conducting network 240A preferably has a lattice geometry, a gyroidal geometry and/or a fractal geometry in two and/or three dimensions, comprising a plurality of nodes, having thermally conducting arms therebetween, with voids between the arms; and wherein the thermally conducting network 240A comprises fluidically interconnected passageways therein, for example within the arms and/or the nodes thereof, for flow therethough of a fluid.

In this example, the first hydrogen storage device 100A comprises a passageway 250A, wherein the first hydrogen storage device 200A is arrangeable in: a first configuration to receive a Joule heater in the passageway 250A; and a second configuration to receive a flow of a liquid through the passageway 250A. In the first configuration, a cartridge heater (not shown) is insertable into the passageway 250A through an end thereof and the opposed end of the passageway 250A is closed, with an insulating plug 260A. In the second configuration, the cartridge heater and the plug 260A are removed and fluid couplings 270A, 280A instead fitted to the ends, such that a recirculating liquid, such as coolant from a fuel cell, may be pumped therethrough.

In this example, the hydrogen storage device 100A is arranged to be oriented horizontally, in use. In this example, the pressure vessel 230A is generally cylindrical, having dished ends. In this example, the passageway, provided by a tube having a circular cross-section, extends between the dished ends longitudinally, offset from an axis of the pressure vessel 230A. In this example, the thermally conducting network 240A partially fills an internal volume of the pressure vessel 230A, particularly a region of the internal volume extending across about 75% of a diameter the pressure vessel, thereby completely surrounding the tube, such that an unfilled volume UV above the thermally conducting network 240A is defined. In this example, the thermally conducting network 240A is thermally coupled to at least a part of an internal surface of the pressure vessel 230A and an external surface of the tube. In this example, the unfilled volume UV acts as a buffer, providing a reservoir of hydrogen during charging and similarly during release, for example to account for kinetics thereof.

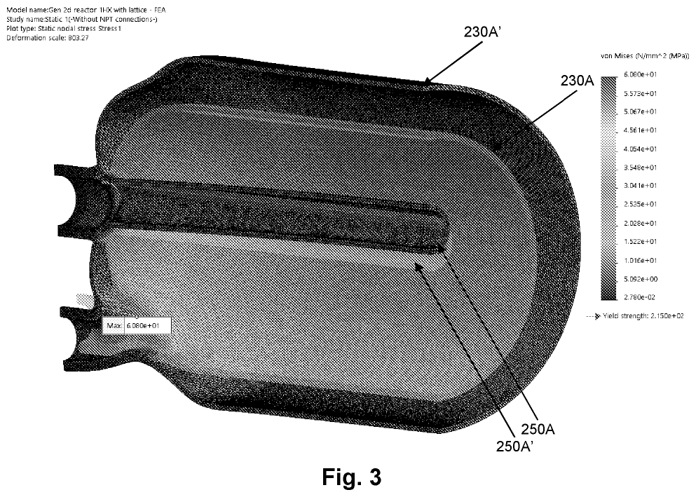

FIG. 3 schematically depicts a cutaway, perspective view of a simulation, particularly by finite element analysis (FEA) the hydrogen storage device of FIG. 1. In this example, the pressure vessel is generally cylindrical, having a wall thickness of 2 mm, and hemispherical dished ends, having a wall thickness of 1.5 mm. In this example, the pressure vessel is formed from a material having a yield stress at 100° C. of 181 MPa. In this example, a maximum stress at an operating pressure of 20 bar is 61 MPa, giving a safety factor of about 3. In this example, a maximum stress at an operating pressure of 5 bar is 15.2 MPa, giving a safety factor of about 11.9. Also shown is the deformed pressure vessel 230A′ and deformed passageway 240A′, following simulated yield.

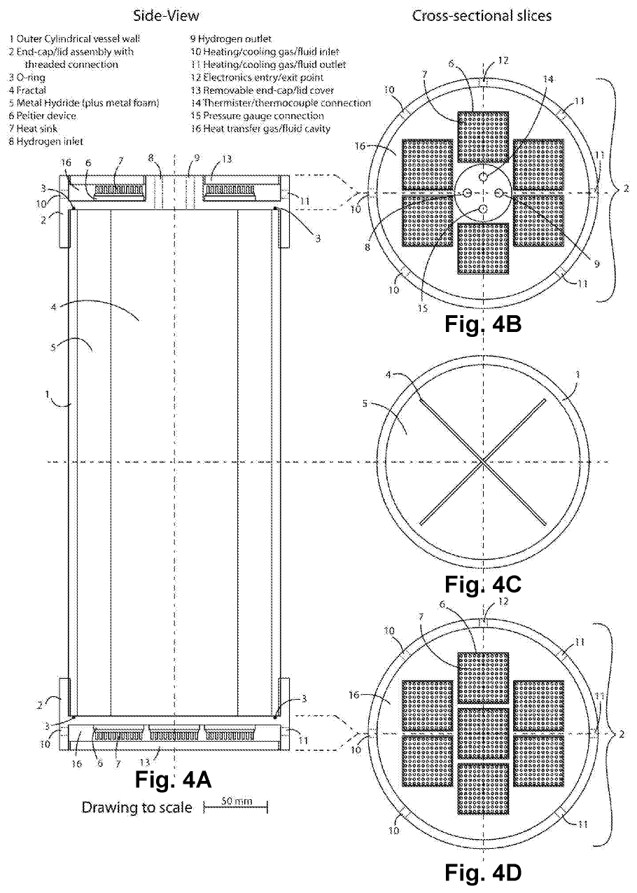

FIG. 4A is a schematic axial cross-section of a hydrogen storage device 200 according to an exemplary embodiment and FIGS. 4B to 4D are schematic transverse cross-sections of the hydrogen storage device 200 of FIG. 4A.

FIGS. 4A-4D show the hydrogen storage device 200. The hydrogen storage device 200 comprises a hollow metal cylinder (outer cylindrical vessel wall (1)) and along with two metallic end-caps (2), providing the pressure vessel. Inside this volume exists the hydrideable metal/metal alloy (5), an aluminium fractal structure (4) with metallic foam in contact with it (not shown in figure). Both end-caps (2) contain an internal cavity for the location of multiple peltier devices (6) and heat/cold sinks (7). In the outer cylindrical vessel wall (1), there are three gas inlets (10) and three gas outlets (11) allow for heating/cooling gas (air) access to this internal cap cavity to add/remove heat. There is also an electronic entry/exit point (12) in the outer cylindrical vessel wall (1). In one of the end-caps four ports (holes) are included, allowing access into the pressure vessel; they are a hydrogen gas inlet (8), a hydrogen gas outlet (9), a pressure sensor connection (15) and a temperature sensor connection (14). The end-caps are held in place and form a seal through a thread and o-ring arrangement (3). The end-caps can be removed for easy access to the pressure vessel. The end-caps have covers (13) which can be removed for easy access to the heating/cooling gas containment volume within them.

In this example, the hydrogen storage device 200 comprises: a pressure vessel 1, having a first fluid inlet 8 and/or a first fluid outlet 9, having therein a thermally conducting network 4 optionally thermally coupled to a first heater and/or a first cooler; wherein the pressure vessel 1 is arranged to receive therein a hydrogen storage material in thermal contact, at least in part, with the thermally conducting network 4; wherein the thermally conducting network 340 has a fractal geometry in two dimensions, comprising a plurality of nodes, having thermally conducting arms therebetween, with voids between the arms; and wherein the thermally conducting network 4 comprises fluidically interconnected passageways therein, within the arms and the nodes thereof, for flow therethough of a fluid.

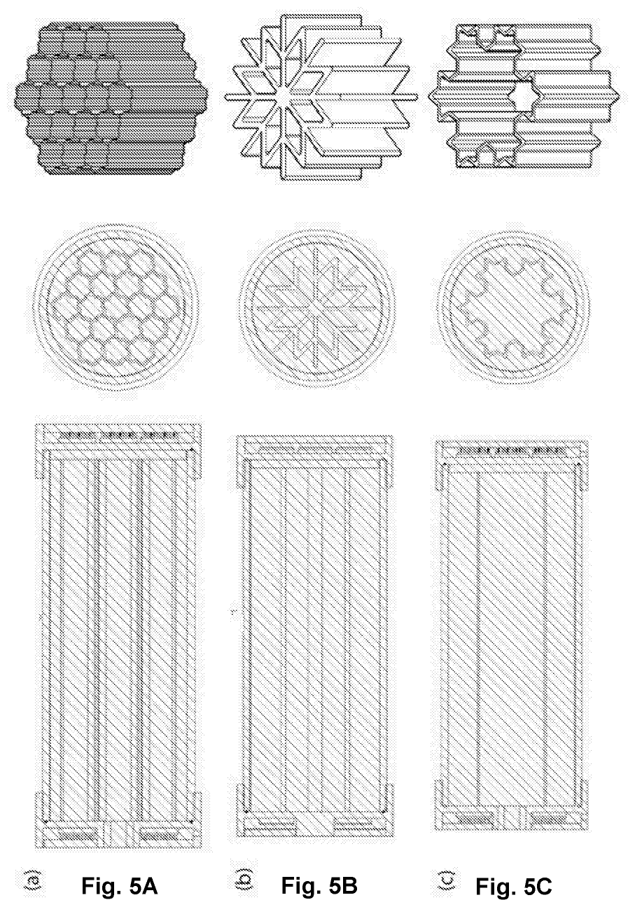

FIGS. 5A to 5C schematically depict thermally conducting networks for a hydrogen storage device according to an exemplary embodiment.

FIG. 5 shows there are shown three alternative fractal networks (A) Gosper Island; (B) ‘Snowflake’ design; and (C) Koch Snowflake for the thermally conducting network of the hydrogen storage device 200. The 2D radially symmetric fractal patterns extend axially. Axial cross-sections, midpoint radial cross-sections and perspective views for the fractal networks are shown.

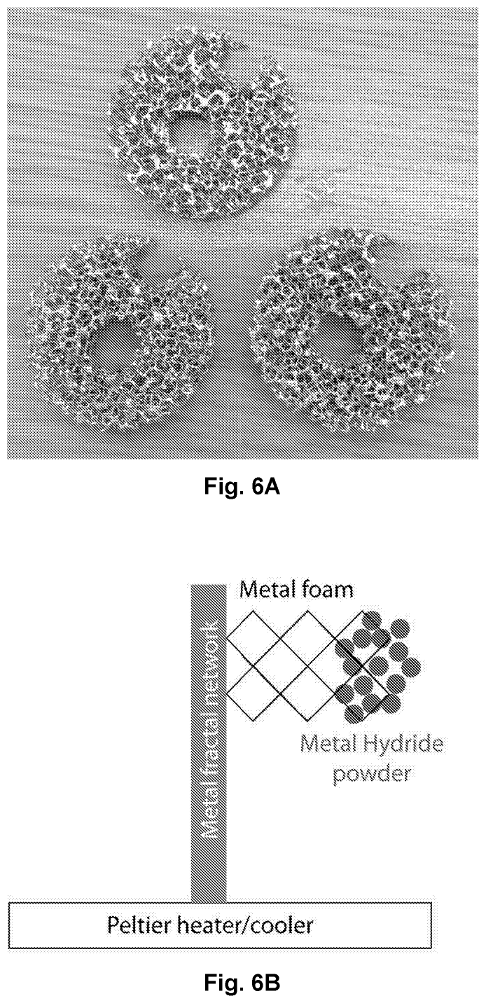

FIG. 6A is a photograph of a foam for a hydrogen storage device according to an exemplary embodiment; and FIG. 6B is a schematic view of a hydrogen storage device according to an exemplary embodiment, in more detail.

FIG. 6A shows a photograph of voids (i.e. open space) in a metal foam, particularly aluminium foam. The aluminium foam is produced from 6101 aluminium alloy, retaining 99% purity of the parent alloy. The foam has a reticulated structure in which cells (i.e. pores) are open and have a dodecahedral shape. The foam has a bulk density of 0.2 g/cm3; a porosity of 93% porosity and about 8 pores/cm.

FIG. 6B schematically depicts a metal hydride powder included and/or in contact with a metal foam which in turn is thermally coupled to a thermally conducting network.

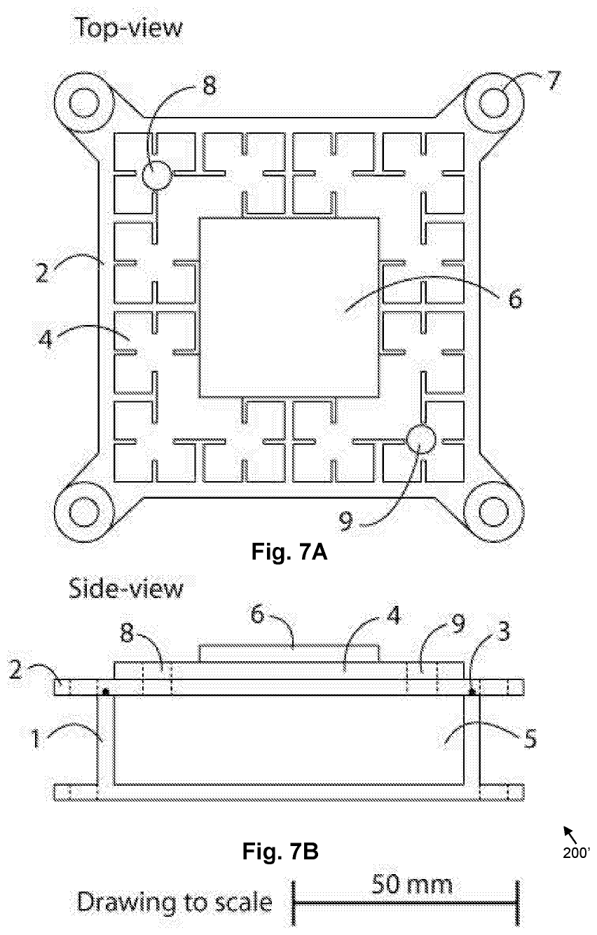

FIG. 7A is a plan elevation view of a hydrogen storage device 200′ according to an exemplary embodiment and FIG. 7B is a side cross-sectional view of the hydrogen storage device 200′ of FIG. 7A.

FIGS. 7A and 7B schematically depict a compact design of a hydrogen storage device 200′. The hydrogen storage device 200′ comprises a hydrogen gas containment volume formed from a cuboid-based container vessel (1) with square-planar lid (2). The lid (2) is secured through the use of four axial-corner screws in screw fixings (7) and it is sealed by an 0-ring (3) positioned between the vessel (1) and the lid (2). The hydrogen containment volume has within it a hydrideable metal/metal alloy (5) and metal foam (not shown). On one surface there is a thermally conducting network (4) having a flat square-based fractal geometry, that acts to dissipate heat radially. A Peltier device (6), thermally coupled to the thermally conducting network (4) and outside of the vessel (1) acts as a heater/cooler. Two holes (8) and (9) located through the lid (2) and the thermally conducting network (4) act as a hydrogen gas inlet (8) and outlet (9), respectively. That is, the hydrogen storage device 200′ comprises the pressure vessel 1, having the first fluid inlet 8 and the first fluid outlet 9, comprising therein a thermally conducting network 4 optionally thermally coupled to the first heater (not shown), wherein the pressure vessel 1 is arranged to receive therein a hydrogen storage material (not shown) in thermal contact, at least in part, with the thermally conducting network 4, wherein the first fluid inlet 8 and/or the first fluid outlet 9 are in fluid communication with the first releasable fluid inlet coupling (not shown) and/or the first releasable fluid outlet coupling (not shown), respectively; and preferably, wherein the thermally conducting network 4 has a lattice geometry and/or a fractal geometry in two and/or three dimensions.

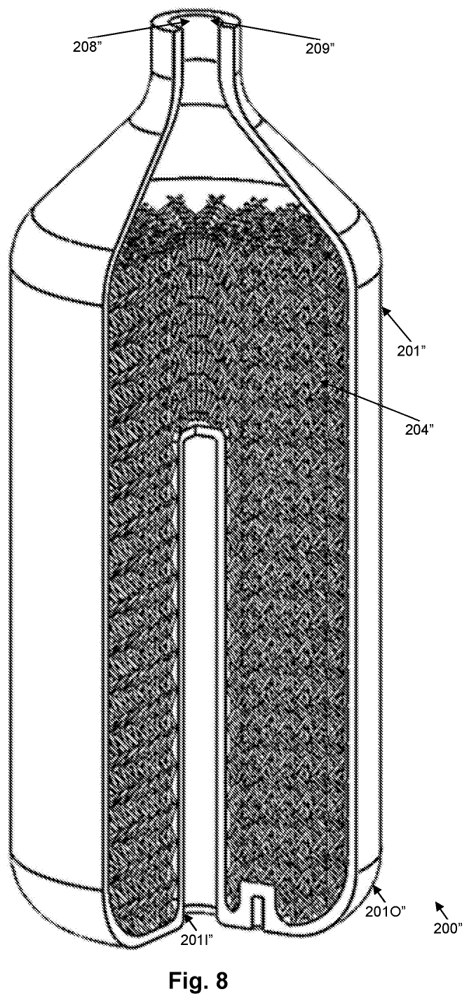

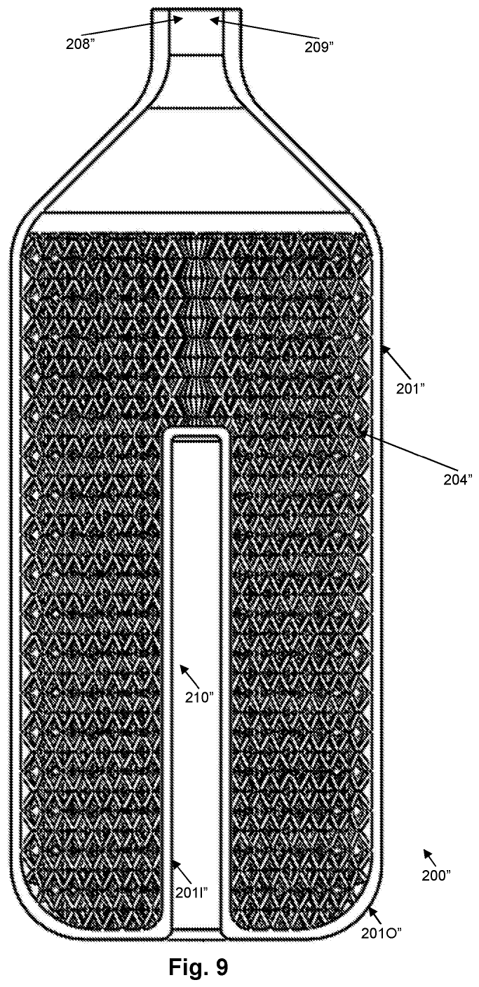

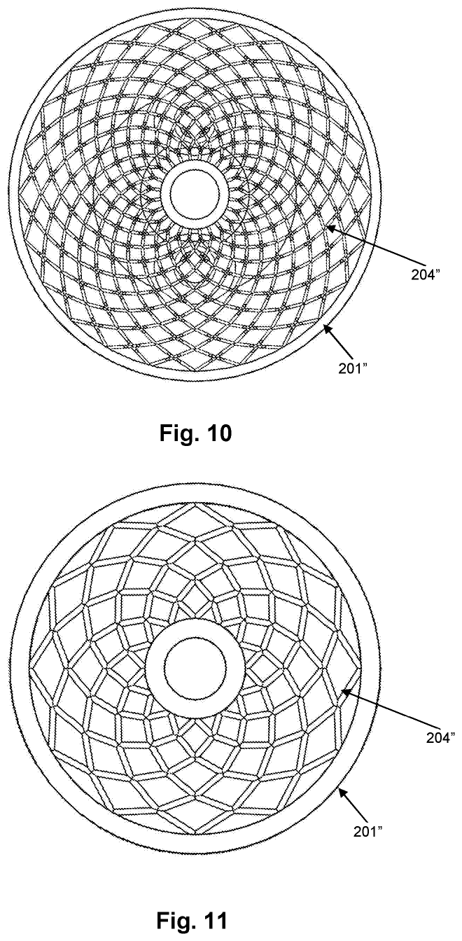

FIG. 8 is CAD cutaway perspective view of a hydrogen storage device 200″ according to an exemplary embodiment. FIG. 9 is CAD axial cross-section of the hydrogen storage device 200″of FIG. 8. FIG. 10 is a CAD radial cross-section of the hydrogen storage device 200″of FIG. 8.

In this example, the hydrogen storage device 200″ comprises: a pressure vessel 201″, having a first fluid inlet 208″ and/or a first fluid outlet 209″, having therein a thermally conducting network 204″ optionally thermally coupled to a first heater and/or a first cooler;

wherein the pressure vessel 201″ is arranged to receive therein a hydrogen storage material in thermal contact, at least in part, with the thermally conducting network 204″; wherein the thermally conducting network 203″ has a fractal geometry in two dimensions, comprising a plurality of nodes, having thermally conducting arms therebetween, with voids between the arms; and wherein the thermally conducting network 204″ comprises fluidically interconnected passageways therein, within the arms and the nodes thereof, for flow therethough of a fluid.

In this example, the pressure vessel 201″ is generally cylindrical, having a generally dished first end and a necked second end opposed thereto, and having a single aperture providing both the first fluid inlet 208″ and the first fluid outlet 209″. In other words, the pressure vessel 201″ is bottle-shaped. An inner wall portion 2011″ of the pressure vessel 201″ provides an axial cylindrical, elongate blind passageway 210″, arranged to receive a first heater 206″ (not shown), that extends from the first end towards the second end and that is coaxial with an outer wall portion 2010″ of the pressure vessel 201″. A second blind passageway in the first end is arranged to receive a thermocouple (not shown).

In this example, the pressure vessel has an internal volume of about 500 cm³, thereby providing a hydrogen storage capacity of about 25 g Hz. In this example, .

In this example, the thermally conducting network 204″ has a lattice geometry in three dimensions. In this example, an effective density of the lattice geometry is uniform in a first dimension, particularly axially, and non-uniform in mutually orthogonal second and third dimensions, particularly radially. Particularly, the effective density decreases radially outwards, such that there is faster heat transfer proximal the passageway 210″ and hence the first heater. In this example, the thermally conducting network 204″ is formed from an aluminium alloy. Alternatively, the thermally conducting network 204″ may be formed from copper, respective alloys thereof such as brass or bronze alloys, and/or stainless steel, as described previously.

FIG. 11 is an alternative CAD radial cross-section for the hydrogen storage device 200″ of FIG. 10. In this example, a node density (i.e. number of nodes per unit volume) of the lattice geometry, generally otherwise similar to the lattice geometry of FIG. 10 mutatis mutandis, is relatively lower than that of the lattice geometry of FIG. 10. A cross-sectional area of the arms is relatively larger than that of FIG. 10.

FIG. 12 is a CAD cutaway perspective view of a hydrogen storage device 200′″ according to an exemplary embodiment. FIG. 13 is a CAD axial cross-section of the hydrogen storage device 200′″ of FIG. 12. In this example, the pressure vessel 201′″ has an internal volume of about 50 cm³, thereby providing a hydrogen storage capacity of about 2.5 g H₂.

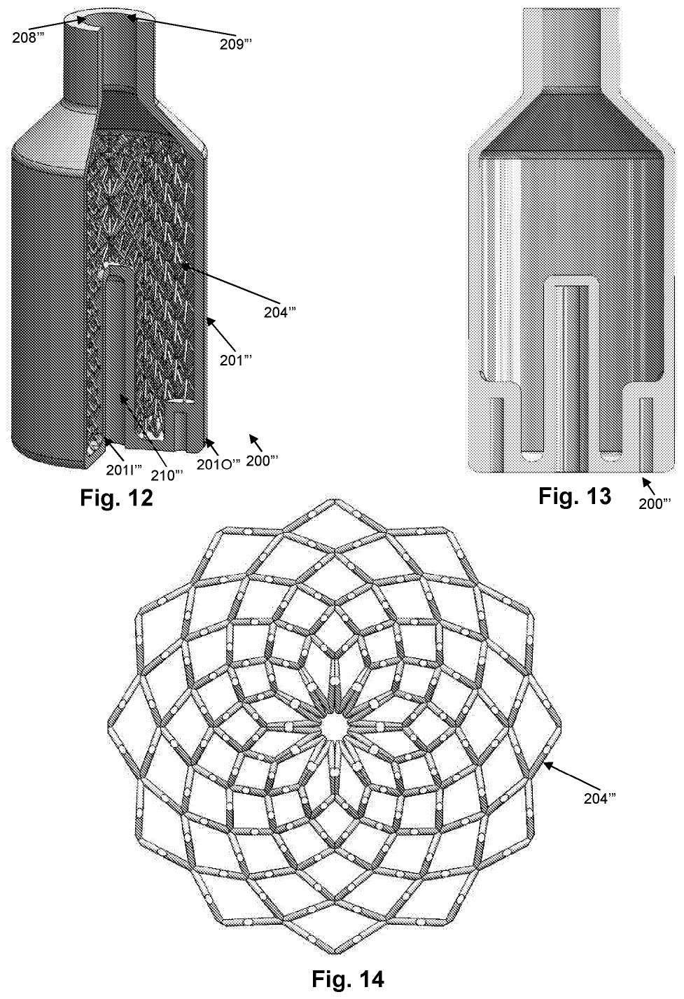

FIG. 14 is a CAD radial cross-section of a thermally conducting network of the hydrogen storage device of FIG. 12. Generally, the lattice geometry is as described with respect to FIG. 11.

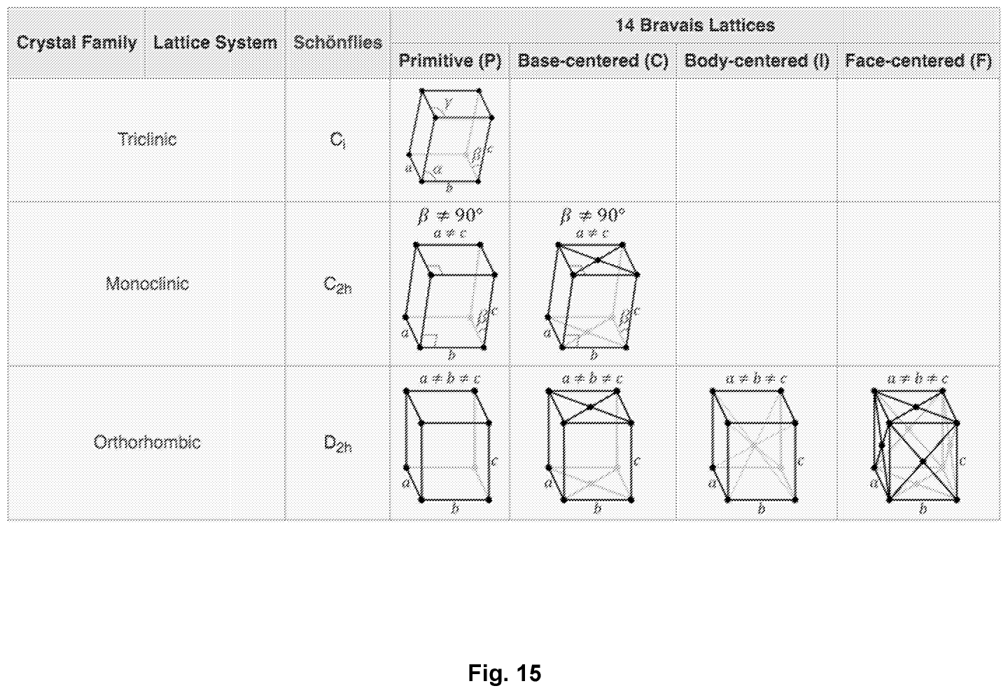

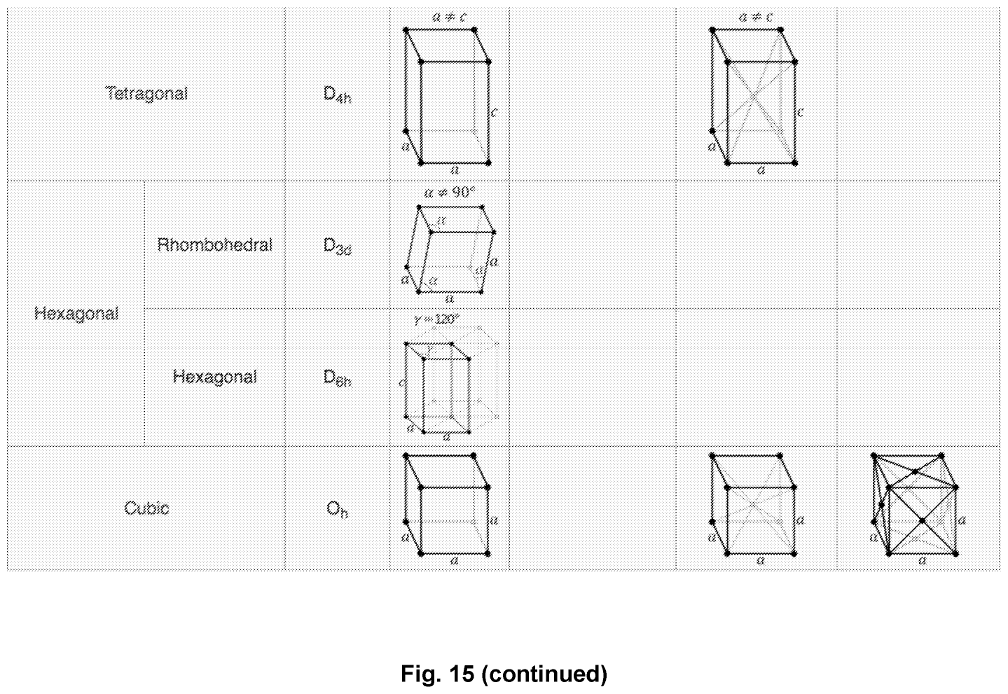

FIG. 15 schematically depicts Bravais lattices for a thermally conducting network, as described above.

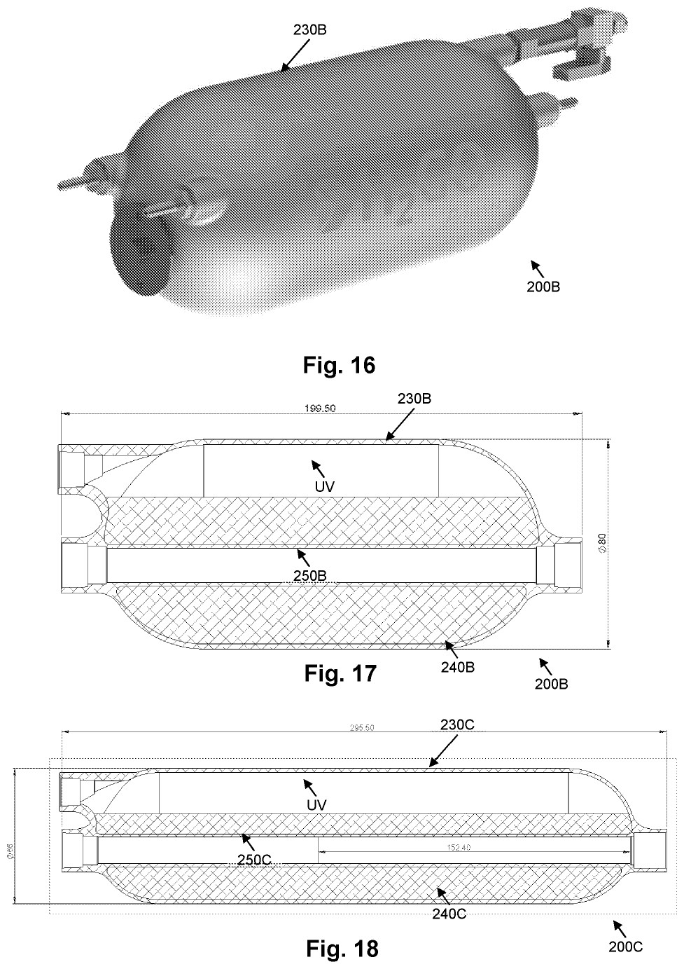

FIG. 16 is a CAD perspective view of a hydrogen storage device 200B according to an exemplary embodiment, generally as described with respect to the hydrogen storage device 200A. FIG. 17 is a CAD axial cross-section of the hydrogen storage device 200B of FIG. 16. In this example, the hydrogen storage device 200B is arranged to be oriented horizontally, in use. In this example, the pressure vessel 230B is generally cylindrical, having dished ends. In this example, a passageway 250B, provided by a tube having a circular cross-section, extends between the dished ends longitudinally, offset from an axis of the pressure vessel 230A. In this example, the thermally conducting network 240B partially fills an internal volume of the pressure vessel, particularly a region of the internal volume extending across about 75% of a diameter the pressure vessel, thereby completely surrounding the tube, such that an unfilled volume above the thermally conducting network 240B is defined. In this example, the thermally conducting network 240B is thermally coupled to at least a part of an internal surface of the pressure vessel 230B and an external surface of the tube. In this example, the unfilled volume acts as a buffer, providing a reservoir of hydrogen during charging and similarly during release, for example to account for kinetics thereof.

FIG. 18 is a CAD axial cross-section of a hydrogen storage device 240C according to an exemplary embodiment, generally as described with respect to FIGS. 16 and 17, having a relatively longer axial length and a relatively smaller diameter.

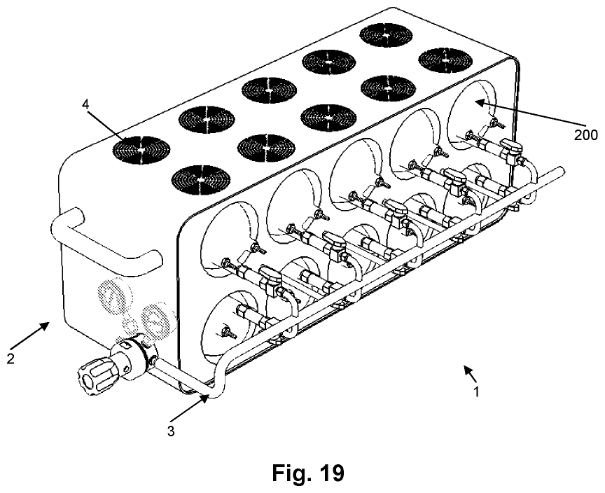

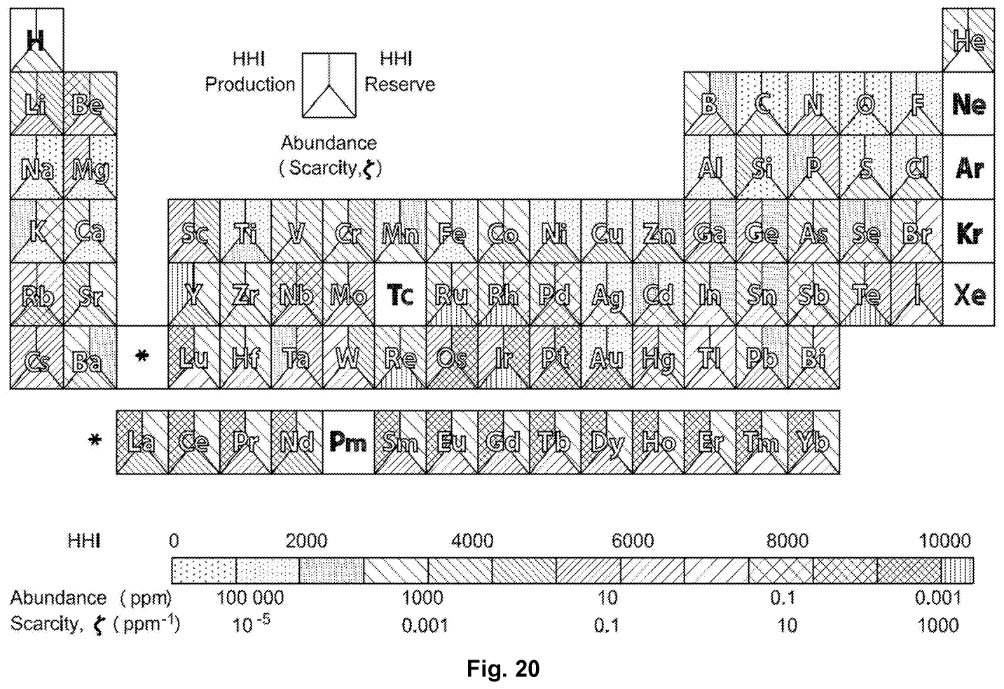

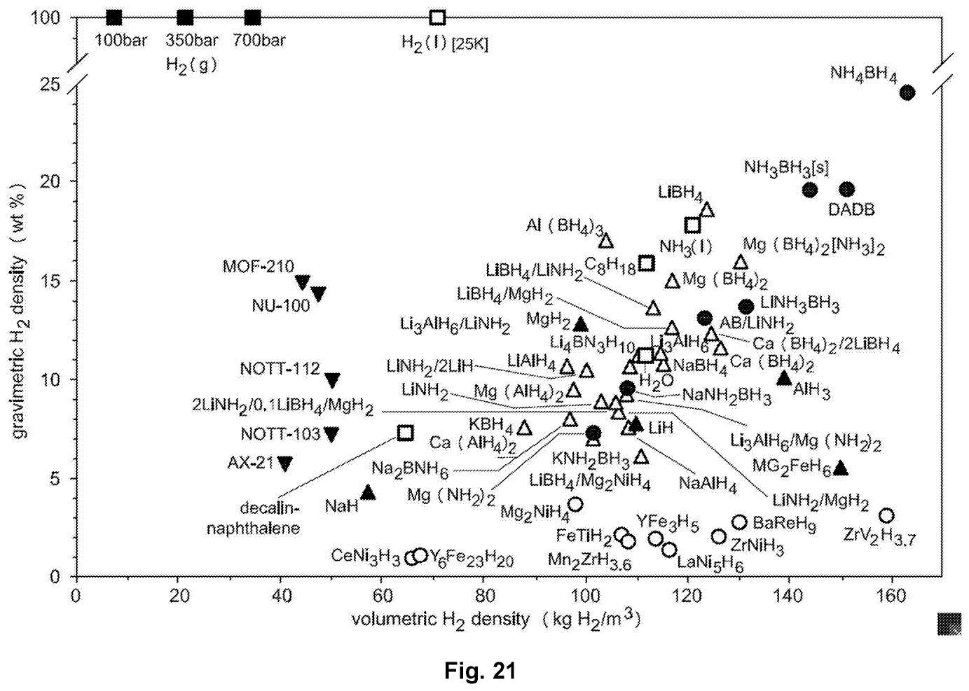

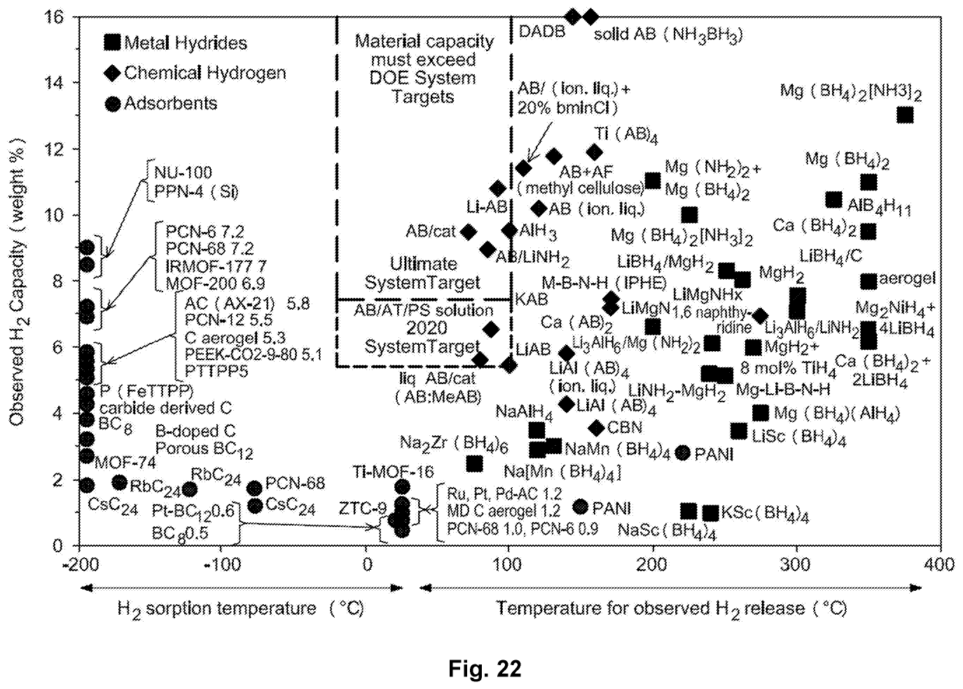

FIG. 19 is a CAD perspective view of a charging station assembly 1 according to an exemplary embodiment. The charging station assembly 1 comprises a charging station 2 and a hydrogen storage device 200. In this example, the charging station 2 is arranged to receive eight hydrogen storage devices, arranged in a bank of 4×2 hydrogen storage devices. In this example, the charging station 2 is arranged to charge a plurality of hydrogen storage devices 200, for example simultaneously. In this example, the charging station 2 comprises a manifold 3 coupleable to the plurality of hydrogen storage devices 200. In this example, the charging station 2 comprises a cooling system 4, arranged to cool a hydrogen storage device during charging thereof. In this example, the cooling system 2 comprises a plurality of fans.

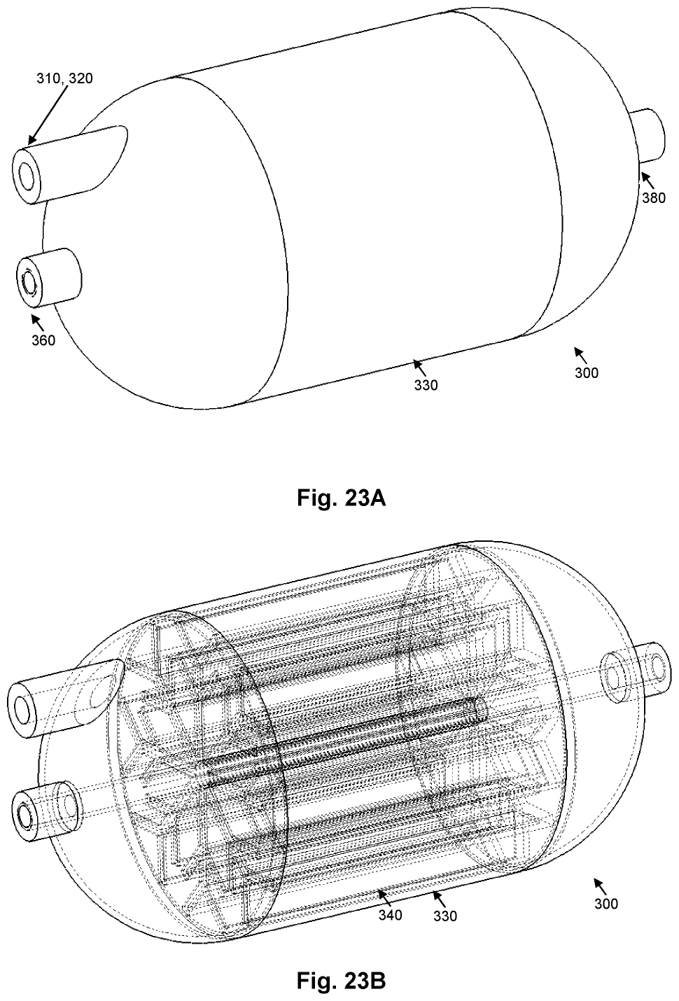

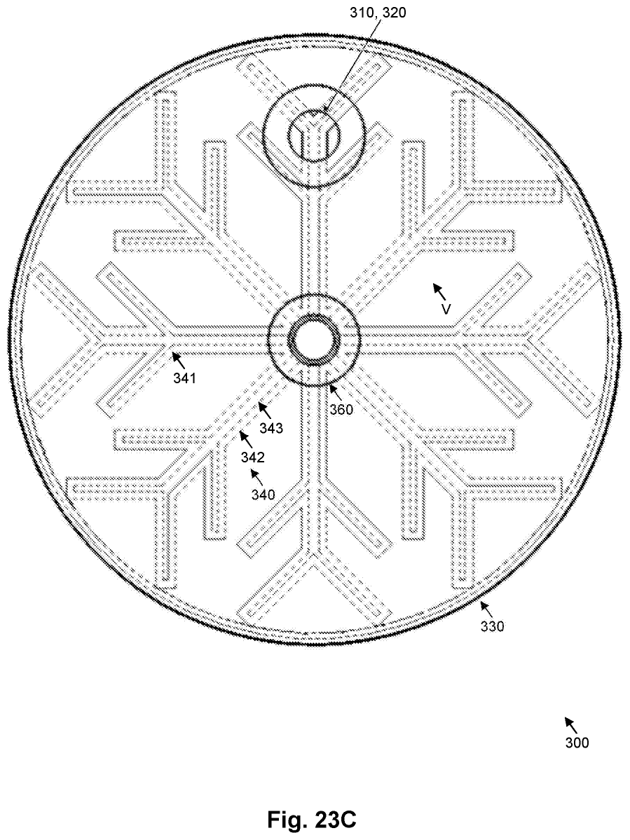

FIG. 23A is a CAD perspective view of a hydrogen storage device 300 according to an exemplary embodiment; FIG. 23B is a CAD perspective semi-transparent view of the hydrogen storage device 300 of FIG. 23A; and FIG. 23C is a CAD axial cross-section view of the hydrogen storage device 300 of FIG. 23A.

In this example, the hydrogen storage device 300 comprises: a pressure vessel 330, having a first fluid inlet 310 and/or a first fluid outlet 320, having therein a thermally conducting network 340 optionally thermally coupled to a first heater and/or a first cooler; wherein the pressure vessel 330 is arranged to receive therein a hydrogen storage material in thermal contact, at least in part, with the thermally conducting network 340; wherein the thermally conducting network 340 has a fractal geometry in two dimensions, comprising a plurality of nodes 341, having thermally conducting arms 342 therebetween, with voids V between the arms 342; and wherein the thermally conducting network 340 comprises fluidically interconnected passageways 343 therein, within the arms 342 and the nodes 341 thereof, for flow therethough of a fluid.

The hydrogen storage device 300 is generally as described with respect to the hydrogen storage device 100A of FIG. 1.

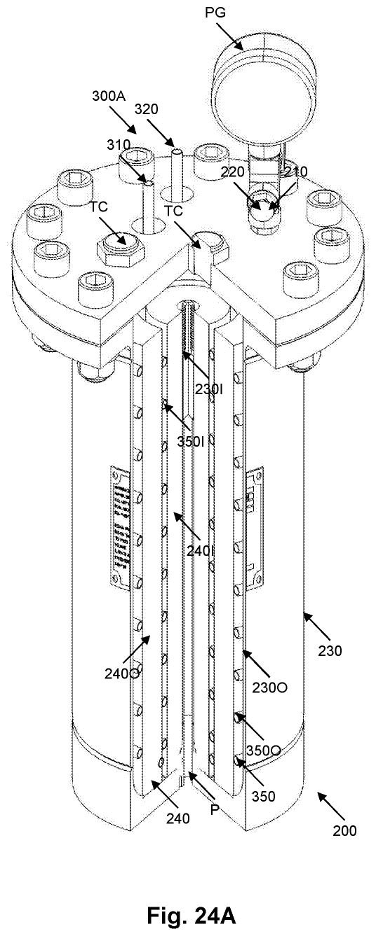

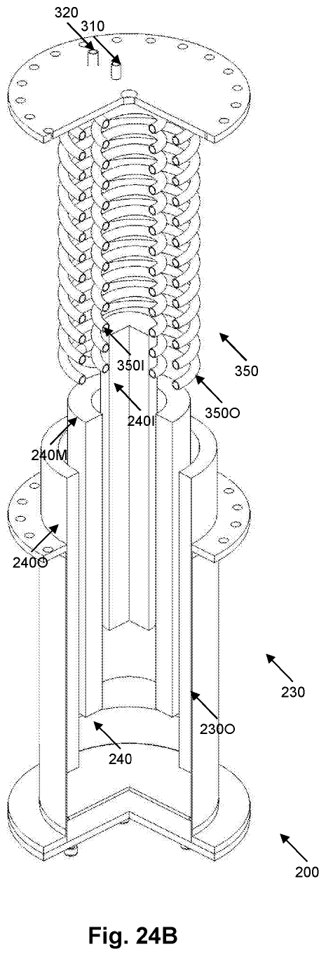

FIG. 24A is a cutaway perspective view of a hydrogen storage device 200 according to an exemplary embodiment. The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively;

and wherein the thermally conducting network 240 has a lattice geometry in three dimensions.

In this example, the pressure vessel 230 is generally cylindrical, having a generally internally dished first end and a flanged second end opposed thereto, and having a single aperture providing both the first fluid inlet 210 and the first fluid outlet 220. In other words, the pressure vessel 230 is can-shaped. An inner wall portion 2301 of the pressure vessel 230 provides an axial cylindrical, elongate blind passageway P, arranged to optionally receive a second heater 300B (not shown) of the set of heaters 300, particularly a cartridge heater (not shown), that extends from the first end towards the second end and that is coaxial with an outer wall portion 2300 of the pressure vessel 230. Blind passageways in the second end are arranged to receive thermocouples TC. In this example, the first heater 300A is provided by a recirculating heater, for example heated using waste heat from a fuel cell coupled thereto, and includes a double helix heating tube 350, having an inlet 310 and an outlet 320, in thermal contact with the thermally conducting network 240, which is arranged between the inner 3501 and outer 3500 helices of the heating tube 350. The double helix heating tube 350 extends from the second end towards the first end is coaxial with an outer wall portion 2300 of the pressure vessel 230. The inner 3501 and outer 3500 helices of the double helix heating tube 350 are directly in thermal contact with the inner wall portion 2301 and the outer wall portion 2300 of the pressure vessel 230, respectively. A pressure gauge PG is provided in the second end. The second end is mechanically releasably coupled to the pressure vessel 230, using mechanical fasteners.

In this example, the thermally conducting network 240 has a lattice geometry in three dimensions, in which generally each node is connected by four arms to four other nodes, respectively, in an axially adjacent preceding layer, such that generally each node is thus connected by eight arms to eight other nodes, four nodes in the axially adjacent preceding layer and four nodes in an axially adjacent proceeding layer. Nodes proximal the inner 3501 and outer 3500 helices of the heating tube 350 are in mutual thermal contact therewith. In this example, an effective density of the lattice geometry is uniform in a first dimension, particularly axially, and non-uniform in mutually orthogonal second and third dimensions, particularly radially. In this example, the thermally conducting network 240 has a porosity of at least 90%. In this example, the thermally conducting network 240 is formed from an aluminium alloy. In this example, the thermally conducting network 240 comprises inner 2401 and outer 2400 portions, having annular shapes. The outer portion 2400 is received in thermal contact with and between the inner 3501 and outer 3500 helices of the double helix heating tube 350 while the inner portion 2401 is received in thermal contact with and within the inner helix 3501.

FIG. 24B is a cutaway perspective exploded view of a related hydrogen storage device 200. In contrast with the hydrogen storage device 200 of FIG. 24A, the thermally conducting network 240 of the hydrogen storage device 200 of FIG. 24B comprises inner 2401, middle 240M and outer 2400 portions. The inner portion 2401 has a cylindrical shape and the middle 240M and outer 2400 portions have annular shapes. The outer portion 2400 is received in thermal contact and without the outer 3500 helices of the double helix heating tube 350, the middle portion 240M is received in thermal contact with and between the inner 3501 and outer 3500 helices while the inner portion 2401 is received in thermal contact with and within the inner helix 3501.

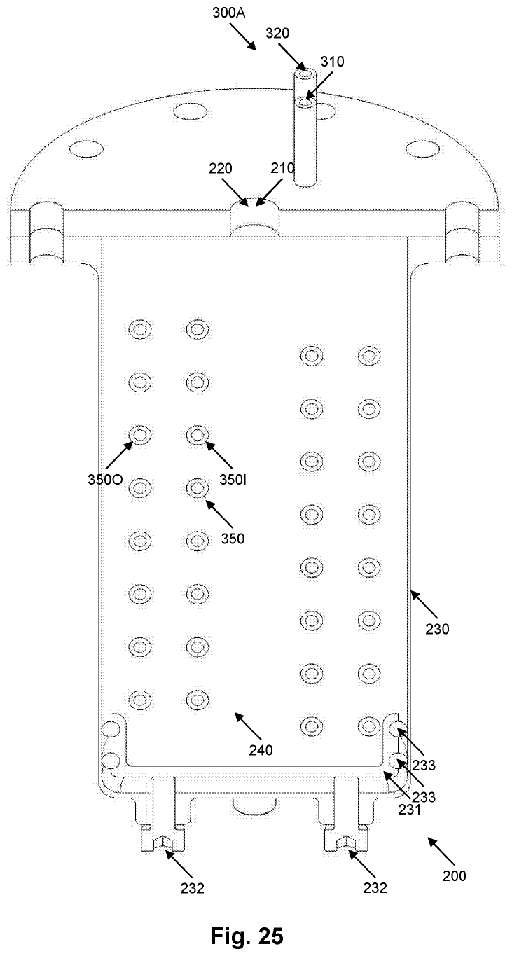

FIG. 25 is a cutaway perspective view of a hydrogen storage device according to an exemplary embodiment. The hydrogen storage device 200 is generally as described with respect to the hydrogen storage devices 200 of FIGS. 24A and 24B and like reference signs denote like features.

In contrast with the hydrogen storage device 200 of FIGS. 24A and 24B, the hydrogen storage device 200 does not include the inner wall portion 2301 of the pressure vessel 230 of FIGS. 24A and 24B and does not include blind passageways in the second end to receive thermocouples. In contrast with the hydrogen storage device 200 of FIGS. 24A and 24B, the thermally conducting network 240 is cylindrical, to be received in thermal contact with the outer wall portion 2300 of the pressure vessel 230. In contrast with the hydrogen storage device 200 of FIGS. 24A and 24B, the inner 3501 and outer 3500 helices of the double helix heating tube 350 are integrated within the thermally conducting network 240. Hence, the inner 3501 and outer 3500 helices of the double helix heating tube 350 are mutually spaced apart from and only indirectly in thermal contact with the outer wall portion 2300 of the pressure vessel 230, respectively, via the thermally conducting network 240. In this example, the hydrogen storage device 200 includes a bed compression disc 231, internal to the pressure vessel 230 proximal the first end and bed compression disc bolts 232 mechanically coupled thereto, extending through the first end, for uniaxially compressing the hydrogen storage material to improve thermal contact with the thermally conducting network. 0-rings 233 are arranged in the outer wall portion 2300 to prevent loss of the hydrogen storage material during compression thereof.

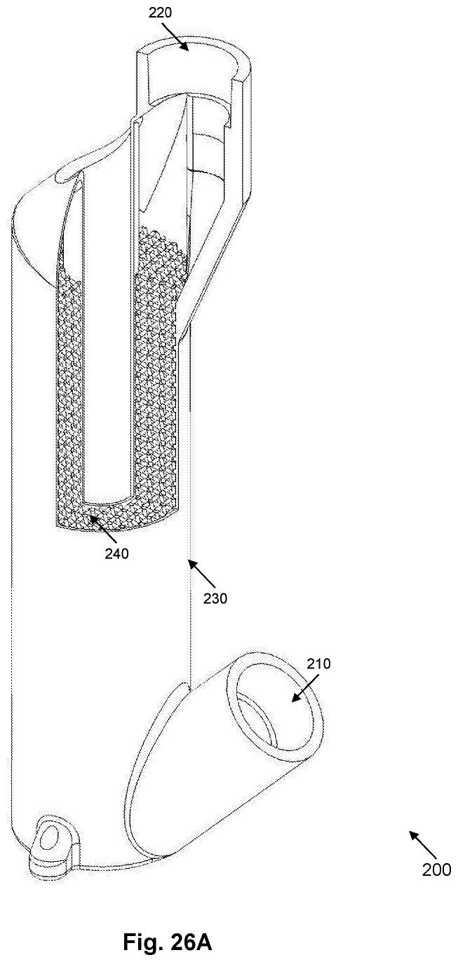

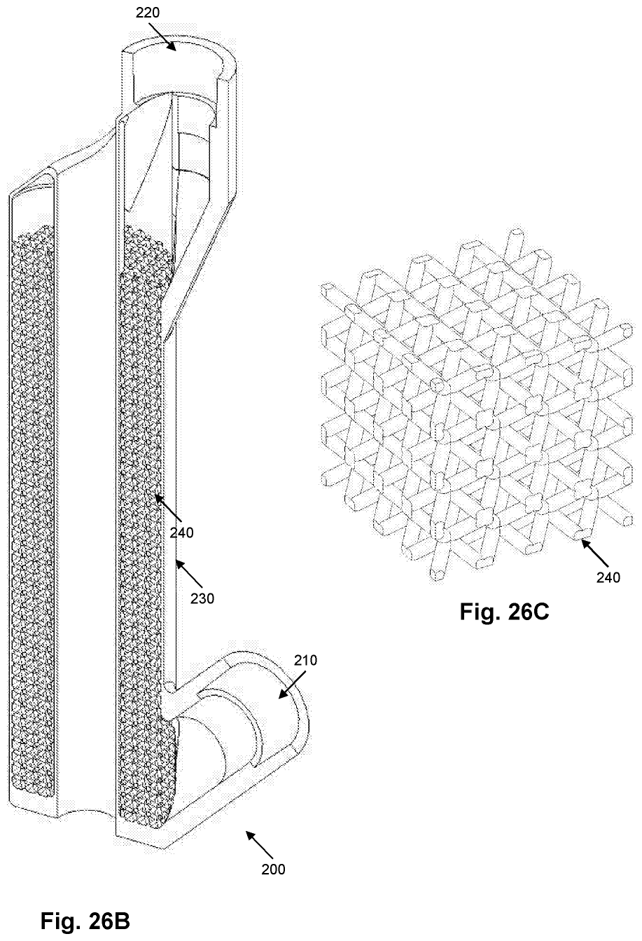

FIG. 26A is a CAD partial cutaway perspective view of a hydrogen storage device 200 according to an exemplary embodiment; FIG. 26B is a CAD longitudinal perspective cross-sectional view of the hydrogen storage device 200; and FIG. 26C is a CAD perspective view of the thermally conducting network, in more detail.

The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively; and wherein the thermally conducting network 240 has a lattice geometry in three dimensions. In this example, the hydrogen storage material comprises and/or is a liquid organic hydrogen carrier, LOHC. In this example, the hydrogen storage device 200 is a dynamic hydrogen storage device 200. In this example, the first fluid inlet 210 and the first fluid outlet 220 are mutually spaced apart at opposed ends of the first vessel 230, thereby defining, at least in part, a path for flow of the hydrogen storage material and/or hydrogen therebetween, for example via the voids of the thermally conducting network 240. In this example, the first fluid inlet 210 and the first fluid outlet 220 comprise releasable couplings, thereby providing coupling thereto and uncoupling therefrom, for example repeatedly, of corresponding couplings. In this example, the lattice geometry is Bravais lattice particularly a cubic lattice specifically a primitive cubic lattice. In this example, the thermally conducting arms have a cross sectional dimension (for example a diameter or a width) of about 0.5 mm. In this example, the thermally conducting network 240 partially fills an internal volume of the first vessel 230, of at least 90%, by volume of the first vessel 230. In this example, the thermally conducting network 240 comprises a LOHC hydrogenation and/or dehydrogenation catalyst, for example provided on and/or in a surface thereof. In this example, the thermally conducting network 240 has a porosity in a range from 75% to 95%, by volume of the thermally conducting network 240. In this example, the thermally conducting network 240 has a specific surface area in a range from 1 m⁻¹ to 10 m⁻¹, particularly about 7 m⁻¹. In this example, the thermally conducting network 240 comprises a LOHC hydrogenation and/or dehydrogenation catalyst, for example provided on and/or in a surface thereof. In this example, the first heater is arranged heat the hydrogen storage material to temperature in a range from 150° C. to 300° C. In this example, the hydrogen storage device 200 comprises a pump (not shown) arranged to flow the hydrogen storage material through the first vessel 230. In this example, the hydrogen storage device 200 is a reactor.

Generally, the first vessel 230 is an elongated cylinder formed from a Ti alloy (to withstand an operating pressure of about 2 bar at a temperature of about 260° C. for dehydrogenation), having a bore extending therethrough for the first heater, particularly a Joule cartridge heater. The first fluid inlet 210 and the first fluid outlet 220 are provided with Swagelok releasable couplings. The first fluid inlet 210 is arranged at an acute angle to the axis of the first vessel and the first fluid outlet is arranged parallel to the axis, to suit the particular application.

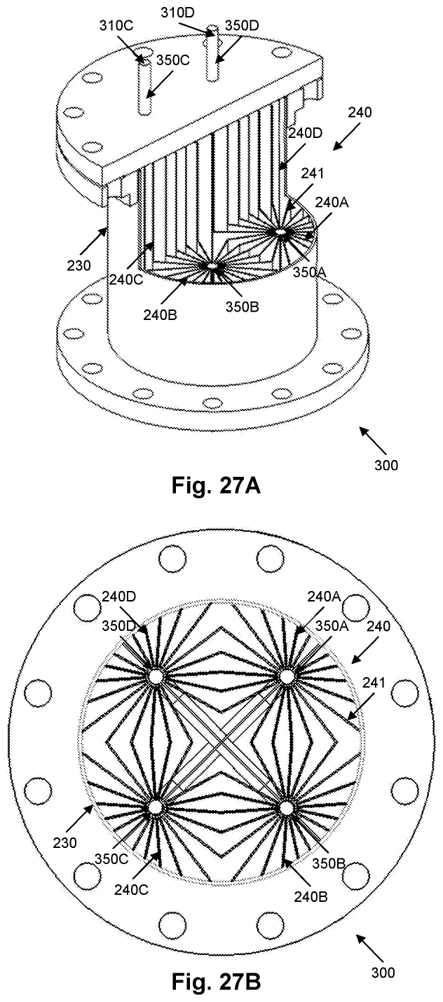

FIG. 27A is a CAD partial cutaway perspective view of a hydrogen storage device 300 according to an exemplary embodiment; and FIG. 27B is a CAD transverse cross-sectional view of the hydrogen storage device 300. The hydrogen storage device 300 is generally as described with respect to the hydrogen storage device 200 of FIGS. 24A and 24B. Like reference signs denote like features. In this example, the thermally conducting network 240 is provided by four extrusions 240A to 240D, for example of aluminium or copper or an alloy thereof (i.e. having a relatively high thermal conductivity), each disposed in a quadrant of the pressure vessel 230 and extending between opposed faces thereof, thereby maximising a length of the pressure vessel 230 benefiting from the thermally conducting network 240. The four extrusions 240A to 240D each comprise 22 planar fins 241 radiating from four heating tubes 350A to 350D, as described below. Ends of the fins of an extrusion are in thermal contact with corresponding fins of an adjacent extrusion or the wall of the pressure vessel 230. Voids between the fins may be filled with a hydrogen storage material. A thermally conducting network having a fractal geometry in two dimensions may similarly be provided by extrusion. In this way, the thermally conducting network 240 may be provided cost effectively, by extrusion. In this example, the first heater 300A is provided by a recirculating heater, for example heated using waste heat from a fuel cell coupled thereto, and includes four heating tubes 350A to 350D, having inlets 310A to 310D and outlets 320A to 320D (not shown) respectively, in thermal contact with the thermally conducting network 240 and extending between opposed faces of the pressure vessel 230.

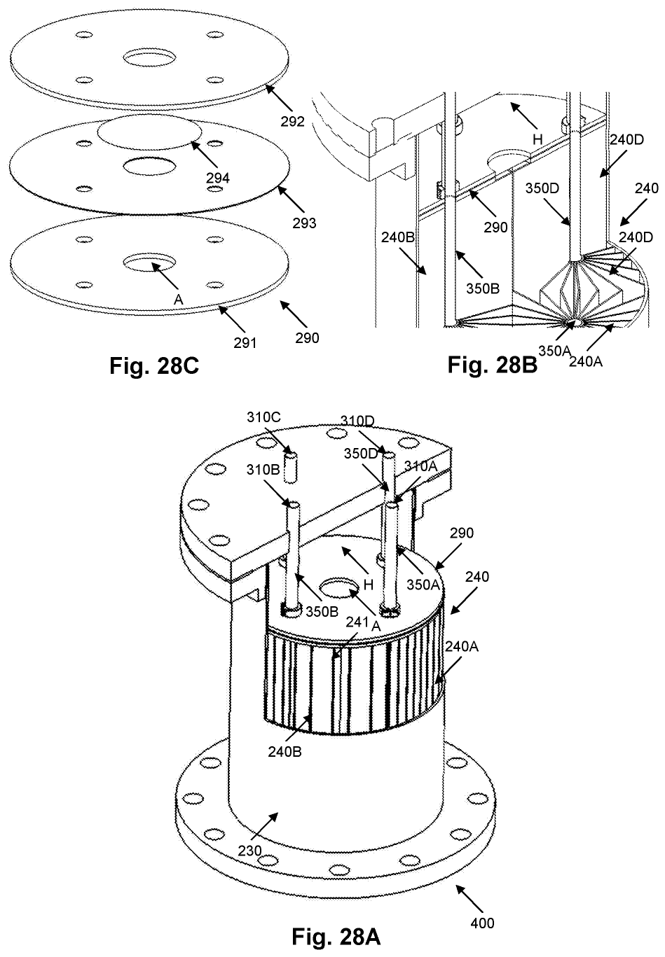

FIG. 28A is a CAD partial cutaway perspective view of a hydrogen storage device 400 according to an exemplary embodiment; FIG. 28B is a CAD partial cutaway perspective view of the hydrogen storage device 400, in more detail; and FIG. 28C is a CAD exploded perspective view of a part of the hydrogen storage device 400, in more detail. The hydrogen storage device 400 is generally as described with respect to the hydrogen storage device 300 of FIGS. 27A to 27B. Like reference signs denote like features. In this example, the four extrusions 240A to 240D extend from one face of the pressure vessel 230 towards the opposed face, with a headspace H disposed thereabove proximal the opposed face for storage of hydrogen, as a buffer. In this way, hydrogen may be stored in the headspace H at a relatively low pressure, for example for start up. The headspace is delimited by a plate assembly 290, comprising a first plate 291, a second plate 292 and a gasket 293 and a mesh 294 therebetween. A central aperture A, covered by the mesh 294, allows hydrogen to flow therethrough while the mesh 294 retains the hydrogen storage material therebelow.

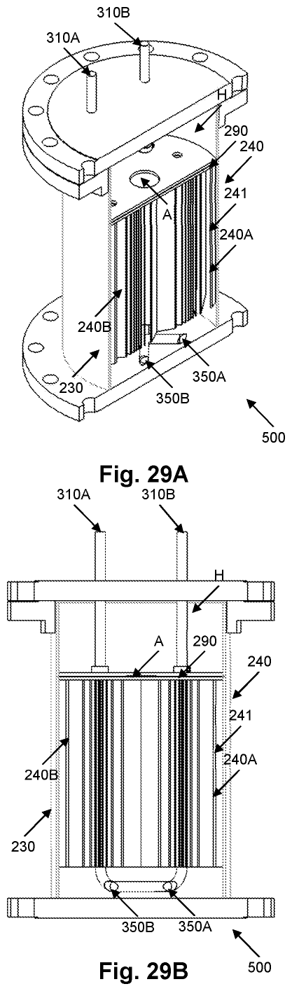

FIG. 29A is a CAD partial cutaway perspective view of a hydrogen storage device 500 according to an exemplary embodiment; and FIG. 29B is a CAD longitudinal cross-sectional view of the hydrogen storage device 500. The hydrogen storage device 500 is generally as described with respect to the hydrogen storage device 400 of FIGS. 28A to 28C. Like reference signs denote like features. In this example, the four extrusions 240A to 240D are spaced apart from both faces of the pressure vessel 230. In this example, the hydrogen storage device 400 includes two U-shaped heating tubes 350A to 350B, having inlets 310A to 310B and outlets 320A to 320B respectively, in thermal contact with the thermally conducting network 240 and projecting from one face towards the opposed face of the pressure vessel 230. By reducing the number of preparations in the pressure vessel 230, potential leakage points are avoided while standard off-the-shelf components may be used. However, the thermally conducting network 240 is relatively shorter.

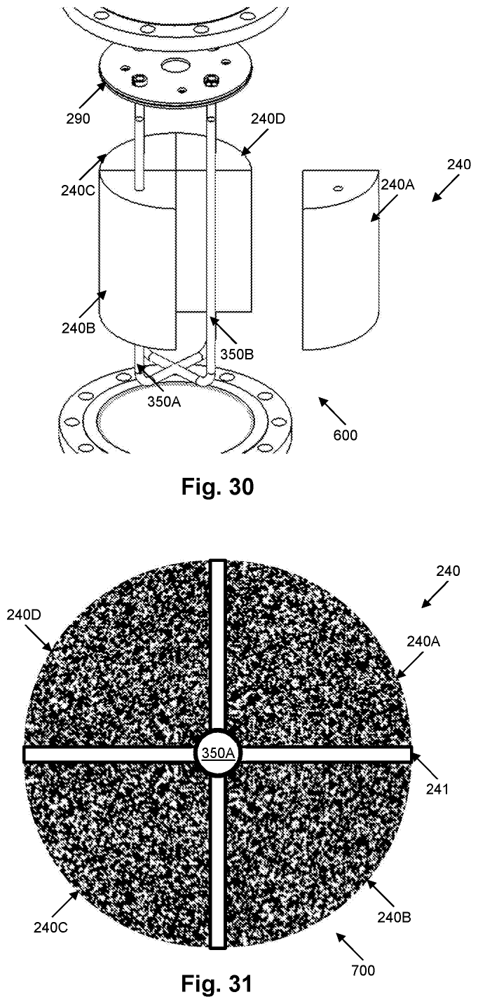

FIG. 30 is a CAD partial cutaway exploded perspective view of a hydrogen storage device 600 according to an exemplary embodiment. The hydrogen storage device 600 is generally as described with respect to the hydrogen storage device 400 of FIGS. 28A to 28C.

Like reference signs denote like features. In this example, the thermally conducting network 240 comprises metal foam quadrants or wedges, for example manufactured by rolling a sheet of foam around a tubular core and subsequently, dividing the rolled foam cylinder. Thermal contact with the walls of the pressure vessel 230 arises from compression of the foam thereagainst.

FIG. 31 is a CAD transverse cross-sectional view of a hydrogen storage device 700 according to an exemplary embodiment. In this example, a hybrid thermally conducting network 240 is provided by an extrusion, as described with respect to FIGS. 27A and 27B, having foam, generally as described with respect to FIG. 31, arranged between the fins.

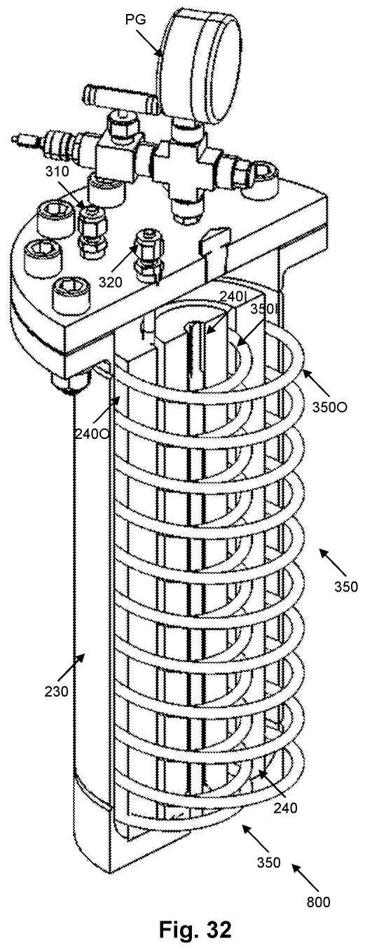

FIG. 32 is a CAD partial cutaway perspective view of a hydrogen storage device 800 according to an exemplary embodiment. The hydrogen storage device 800 is generally as described with respect to the hydrogen storage device 200 of FIGS. 24A and 24B. Like reference signs denote like features. In this example, the thermally conducting network 240 comprises an aluminium foam having a porosity of 93%. Alternatives

Although a preferred embodiment has been shown and described, it will be appreciated by those skilled in the art that various changes and modifications might be made without departing from the scope of the invention, as defined in the appended claims and as described above.

### Summary

In summary, the invention provides a hydrogen storage device comprising: a pressure vessel, having a first fluid inlet and/or a first fluid outlet, having therein a thermally conducting network optionally thermally coupled to a first heater and/or a first cooler; wherein the pressure vessel is arranged to receive therein a hydrogen storage material in thermal contact, at least in part, with the thermally conducting network; wherein the thermally conducting network preferably has a lattice geometry, a gyroidal geometry and/or a fractal geometry in two and/or three dimensions, comprising a plurality of nodes, having thermally conducting arms therebetween, with voids between the arms; and wherein the thermally conducting network comprises fluidically interconnected passageways therein, for example within the arms and/or the nodes thereof, for flow therethough of a fluid.

In this way, control for charging and/or release of hydrogen from the hydrogen storage device is improved because the flow of the fluid through the interconnected passageways in the thermally conducting network provides for faster, more homogenous, more accurate and/or more precise heating and/or cooling of the thermally conducting network and in turn, the hydrogen storage material in thermal contact therewith. Additionally and/or alternatively, in this way, storing and/or release of the hydrogen may be accelerated since heat generated or required, respectively, may be provided by the flow of the fluid through the interconnected passageways in the thermally conducting network. Disclosure

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A hydrogen storage device comprising:
a pressure vessel, having a first fluid inlet and/or a first fluid outlet, having therein a thermally conducting network optionally thermally coupled to a first heater and/or a first cooler;
wherein the pressure vessel is arranged to receive therein a hydrogen storage material in thermal contact, at least in part, with the thermally conducting network;
wherein the thermally conducting network has a lattice geometry, a gyroidal geometry and/or a fractal geometry in two and/or three dimensions, comprising a plurality of nodes, having thermally conducting arms therebetween, with voids between the arms; and
wherein the thermally conducting network comprises fluidically interconnected passageways therein for flow therethough of a fluid.

2. The hydrogen storage device according to claim 1, wherein the hydrogen storage device is arrangeable in:
a first arrangement wherein the thermally conducting network is within the pressure vessel; and
a second arrangement wherein the thermally conducting network is outside the pressure vessel.

3. The hydrogen storage device according to claim 1, wherein the hydrogen storage material comprises one or more selected from: a metal a hydride salt of a metal a borohydride salt of a metal borohydride salt of ammonium and/or alkyl ammonium; and mixtures thereof.

4. The hydrogen storage device according to claim 1, wherein the hydrogen storage material comprises and/or is an ABₓ alloy, wherein A is at least one selected from a group consisting of La, Ce, Pr, Nd, Ca, Y, Zr, and Mischmetal, wherein B is at least one selected from a group consisting of Ni, Co, Mn, Al, Cu, Fe, B, Sn, Si, Ti, and xis in a range from 4.5 to 5.5.

5. The hydrogen storage device according to claim 1, wherein the hydrogen storage material comprises and/or is an AB/A₂B alloy, wherein A is at least one selected from a group consisting of Ti and Mg, and B is at least one selected from a group consisting of Ni, V, Cr, Zr, Mn, Co, Cu, and Fe.

6. The hydrogen storage device according to claim 1, wherein the hydrogen storage material comprises and/or is an AB₂ alloy, wherein A is at least one selected from a group consisting of Ti, Zr, Hf, Th, Ce and rare earth metals, and B is at least one selected from a group consisting of Ni, Cr, Mn, V, Fe, Mn and Co.

7. The hydrogen storage device according to claim 1, wherein the hydrogen storage material comprises and/or is a metal hydride.

8. The hydrogen storage device according to claim 7, wherein the hydrogen storage material comprises one or more metal hydrides selected from a group consisting of: lithium hydride (LiH), sodium hydride (NaH), potassium hydride (KH), beryllium hydride (BeH₂), magnesium hydride (MgH₂), calcium hydride (CaH₂), strontium hydride(SrH₂), titanium hydride (TiH₂), aluminum hydride (AlH₃), boron hydride(BH₃), lithium borohydride (LiBH₄), sodium borohydride (NaBH₄), magnesium borohydride (Mg(BH₄)₂), calcium borohydride (Ca(BH₄)₂), lithium alanate (LiAlH₄), sodium alanate (NaAlH₄), magnesium alanate (Mg(AlH₄)₂), calcium alanate (Ca(AlH₄)₂), and mixtures thereof.

9. The hydrogen storage device according to claim 7, wherein hydrogen storage material comprises and/or is one or more metal hydrides selected from MgH₂, NaAlH₄, LiAlH₄, LiH, LaNi₅H₆, TiFeH₂, palladium hydride PdHₓ, LiNH₂, LiBH₄ and NaBH₄.

10. The hydrogen storage device according to claim 3, wherein the hydrogen storage material comprises an ABₓ alloy, an AB/A₂B alloy, an AB₂ alloy, a hydride and/or a mixture thereof.

11. The hydrogen storage device according to claim 1, wherein the hydrogen storage material comprises a dopant.

12. The hydrogen storage device according to claim 1, having a hydrogen storage density of at least 0.01 wt. % of the hydrogen storage vessel.

13. The hydrogen storage device according to claim 1, wherein the fractal geometry is selected from a group consistant of: Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge, a Jerusalem cube, and a 3D H-fractal.

14. The hydrogen storage device according to claim 1, wherein an effective density of the lattice geometry is uniform in a first dimention and non-uniform in mutually orthogonal second and third dimensionsl.

15. The hydrogen storage device according to claim 1, wherein the lattice geometry is Bravais lattice a monoclinic; an orthorhombic; a tetragonal; a hexagonal; or a cubic lattic.

16. The hydrogen storage device according to claim 1, wherein the thermally conducting arms have a cross sectional dimension in a range from 0.1 mm to 10 mm and/or a length in range from 0.5 mm to 50 mm.

17. The hydrogen storage device according to claim 1, wherein the thermally conducting network is formed, at least in part, by additive manufacturing and/or by casting.

18. The hydrogen storage device according to claim 1, comprising a thermally-conducting foam.

19. The hydrogen storage device according to claim 1, wherein the thermally conducting network partially fills an internal volume of the pressure vessel, of at least 50% by volume of the pressure vessel, thereby defining an unfilled volume.

20. The hydrogen storage device according to claim 1, wherein the first heater comprises a Joule heater and/or a recirculating heater. cm 21-26. (canceled)
